(19) United States
(12) Patent Application Publication
(10) Pub. No.: US 2011/0293813 A1
(43) Pub. Date: Dec. 1, 2011

(54) FROZEN PELLETS MADE WITH JUICE

(75) Inventors: Vincent M. Cavallini, Inver Grove Heights, MN (US); Joseph L. Klemaszewski, Plymouth, MN (US); Karla Jean Nelson, Minneapolis, MN (US); John F. Sweeney, Lebanon, PA (US)

(73) Assignee: CARGILL, INCORPORATED, Wayzata, MN (US)

(21) Appl. No.: 13/054,653

(22) PCT Filed: Jul. 17, 2009
(86) PCT No.: PCT/US09/51031

§ 371 Date: Apr. 7, 2011

Related U.S. Application Data
(60) Provisional application No. 61/135,277, filed on Jul. 18, 2008.

(51) Int. Cl. A23L 1/05; A23G 9/04; A23G 9/42; A23G 9/32; A23L 1/0532; A23L 1/0526

(52) U.S. Cl. 426/575; 426/573

(57) ABSTRACT

A composition and method of making frozen pellets made with juice includes a composition having at least about 50 weight equivalents of juice and a multipart stabilizer that acts as a gelling agent and a viscosifying agent. Frozen pellets are formed from the composition through cryogenic freezing. The resulting pellets contain a high level of juice and have a creamy taste and mouth feel. The multipart stabilizer results in the frozen pellets being free flowing at temperatures below approximately −4° F. Moreover, the multipart stabilizer contributes to the pellets having a high resistance to melting and clumping. In some embodiments, the frozen pellets made with juice are blended with frozen pellets made with yogurt to form a frozen food product.

### CROSS REFERENCE TO RELATED APPLICATION

This application claims benefit of U.S. Ser. No. 61/135,277 filed 18 Jul. 2008 entitled FROZEN PELLETS MADE WITH JUICE, which is hereby incorporated by reference in its entirety.

### TECHNICAL FIELD

This invention relates to frozen food products, and more particularly to compositions and methods of making frozen pellets containing juice.

### BACKGROUND

Frozen food products that are fruit flavored or contain juice, such as fruit bars, have at least some of the icy refreshing qualities of ice cream type products, but usually do not have a creamy texture and mouth feel. However, juice based products may be preferred over ice cream products, especially by parents, based on nutritional value. Consumers, particularly children, may benefit from a frozen juice product having a significant amount of juice, while simultaneously having a creamy taste and satisfying mouth feel.

### SUMMARY

Compositions and methods of making frozen pellets made with juice are described herein. The frozen pellets made with juice are formed from a composition having at least about 50 weight equivalents of juice and a multipart stabilizer. The frozen pellets may be offered as a nutritional food product having a significant amount of juice and a satisfying creamy taste and mouth feel.

In one embodiment, the invention comprises a food product in pellet form and formed from a composition comprising at least about 50 weight equivalents of juice and a multipart stabilizer that acts as a gelling agent and a viscosifying agent. The viscosity of the composition is at least 250 centipoise. In some aspects, the juice comprises a first juice that provides flavor to the composition and a second juice that provides sweetness and flavor to the composition. The flavor provided by the second juice is lower than the flavor provided by the first juice. In some preferred aspects, the second juice has a single strength Brix value less than 13.

In another embodiment, the invention is a frozen food product comprising a plurality of substantially, free flowing pellets formed from a composition having juice comprising at least about 50 weight equivalents and milk solids comprising at least about two weight percent of the composition. The composition also includes a multipart stabilizer that acts as a gelling agent and a viscosifying agent to increase a viscosity of the composition used to form the pellets as compared with a comparable composition not containing the multipart stabilizer. In some preferred aspects, the food product is substantially free flowing pellets having an average diameter from about 4 to about 10 millimeters. Typically, the free flowing pellets do not exhibit any appreciable clumping at a temperature less than about −20 degrees Celsius.

In another embodiment, the invention is a composition suitable for making a frozen food product. The composition includes about 100 weight equivalents of juice, about 0.1 to about 0.6 weight percent of a flavoring, about 1 to about 5 weight percent of a fructo-oligosaccharide, about 2 to about 6 weight percent of nonfat dry milk, about 1 to about 3 weight percent of a heavy cream, and about 0.3 to about 1.0 weight percent of a stabilizer comprising at least one of sodium alginate, carrageenan, locust bean gum, xanthan gum and guar gum. In some preferred aspects, sodium alginate comprises about 0.05 to about 0.4 weight percent of the composition; carrageenan comprises about 0.05 to about 0.4 weight percent of the composition; locust bean gum comprises about 0.05 to about 0.4 weight percent of the composition; and guar gum comprises about 0.01 to about 0.3 weight percent of the composition.

In another embodiment, the invention is a composition for forming a frozen food product including at least about 50 weight equivalents of juice and a multipart stabilizer that acts as a viscosifying agent and a gelling agent. The stabilizer comprises from about 0.2 to about 2.0 weight percent of the composition. The composition has a viscosity from about 250 to about 450 centipoise.

In another embodiment, the invention is a method of making a frozen food product. The method includes obtaining a composition including about 50 to about 100 weight equivalents of juice, about 2 to about 5 weight percent of milk solids and a multipart stabilizer. The method further includes pasteurizing the composition and cryogenically freezing the composition to form a plurality of free flowing pellets.

In another embodiment, the invention is a food product including a first set of pellets formed from a first composition comprising at least about 50 weight equivalents of juice and a first stabilizer. The food product also includes a second set of pellets formed from a second composition comprising nonfat milk, at least three percent yogurt and a second stabilizer. In preferred aspects, a weight ratio of the first set of pellets to the second set of pellets is 1:1.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

The details of one or more embodiments of the invention are set forth in the description below. The detailed embodiments described below are illustrative only and are not intended to be limiting. Other features, objects, and advantages of the invention will be apparent from the detailed description, the figures, and from the claims.

### BRIEF DESCRIPTION OF THE DRAWINGS

FIG. 1 is a melting profile showing heat flow versus temperature obtained using differential scanning calorimetry (DSC) of frozen pellets made with juice.

FIG. 2 is a melting profile similar to FIG. 1 for frozen pellets made with yogurt.

FIG. 3 is a plot of melting rate as a function of time for the frozen juice pellets made with juice from FIG. 1.

FIG. 4 is a plot similar to FIG. 3 for the frozen juice pellets made with yogurt from FIG. 2.

FIG. 5 is a plot of melting rates as a function of time for four formulations of frozen juice pellets made with varying stabilizer compositions.

FIG. 6 is a plot of melting rates as a function of time for four additional formulations of frozen juice pellets made with four additional combinations of stabilizer compositions.

### DETAILED DESCRIPTION

The invention provides a frozen food product, compositions and methods for producing the frozen food product. The food product includes frozen pellets made with juice, which may be generally spherical in shape. Prior to consumption, the frozen pellets typically are stored in a freezer, which is commonly at temperatures of about 0° F. to about −4° F. (about −17.8° C. to about −20° C.). In preferred aspects, the frozen pellets contain a high level of juice. In some particularly preferred aspects, the pellets contain milk fat and nonfat milk solids.

The frozen pellets are free flowing at temperatures below about −4° F. For purposes of this disclosure, free flowing means that the pellets are independent of one another and do not exhibit any appreciable clumping. The pellets are also free flowing if light clumping can readily be removed by slight agitation of the pellets. As described in further detail below, the frozen pellets are described as being stable. For purposes of this disclosure, stable or stability refers to the pellets remaining free flowing at temperatures less than about −4° F. (i.e. when the pellets are stored inside a residential or commercial freezer) and during normal freeze/thaw cycles and/or defrost cycles that self-defrosting freezers typically undergo. In some aspects, it is believed that the pellets are also free flowing at temperatures of about 0° F. Moreover, as used herein, stable or stability refers to the pellets having a high relative resistance to melting (relatively low melting rate, for example, at 21 degrees Celsius, relative to frozen pellets only containing juice and not any stabilizer. The stability of the pellets makes the pellets resist melting and ultimately clumping during freeze/thaw cycles and/or may result in pellets that melt more slowly when removed from the freezer. A multipart stabilizer, which may include viscosifying and gelling agents, provides stability to the pellets.

Because the frozen pellets made from juice contain a high level of juice, the pellets are a healthy dessert choice, while exhibiting a creamy mouth feel, similar to a mouth feel exhibited by sherbet. The free flowing pellets, which may be particularly attractive to children, provide a distinctive frozen food product as a unique alternative to conventional frozen food products. In some embodiments, the frozen food product may include frozen pellets made with juice in combination with frozen pellets made with yogurt.

Frozen Pellets Made with Juice

The frozen pellets are formed from a composition or a mix that is cryogenically frozen (i.e. at temperatures less than 120 Kelvin) to form the pellets. The composition or mix used to form the pellets is described in further detail below. The frozen pellets may be referred to as pellets or beads and may have any shape, size, volume, surface area and color. In some preferred embodiments, the pellets are generally spherical in shape and may have an average diameter of from about 1 to about 20 millimeters (mm). In some particularly preferred aspects, the pellets have an average diameter of from about 4 to about 10 mm. As described herein, average diameter is determined using methods known to one skilled in the art. For a pellet having an irregular shape, the average diameter is the length of the longest cross section that can be cut through the body of the pellet. As described further below, the size of the pellets may depend, in part, on the properties of the composition used to form the pellets (for example, viscosity), as well as the equipment used to form the pellets from the composition. The size of the pellets impacts the mouth feel and overall sensory experience. Moreover, the size of the pellets is based, in part, on making an attractive food product, particularly for children.

The frozen pellets made with juice may include any type of juice, including, but not limited to, apple juice, pear juice, strawberry juice, grape juice (including white grape), orange juice, acerola juice, apricot juice, banana juice, blackberry juice, blueberry juice, boysenberry juice, cantaloupe juice, carambola (starfruit) juice, carrot juice, casaba juice, cashew (caju) juice, celery juice, cherry (dark sweet and red sour) juice, crabapple juice, cranberry juice, currant (black and red) juice, date juice, dewberry juice, elderberry juice, fig juice, gooseberry juice, grapefruit juice, guanabana (soursoup) juice, guava juice, honeydew juice, kiwi juice, lemon juice, lime juice, loganberry juice, mango juice, nectarine juice, papaya juice, passionfruit juice, peach juice, pineapple juice (including clarified), plum juice, pomegranate juice, prune juice, quince juice, raspberry (black and red) juice, rhubarb juice, tangerine juice, tomato juice, watermelon juice, and youngberry juice.

As described in detail below, particular juices may be preferred for use in the frozen pellets based, in part, on desired flavor and an amount of soluble solids in the juice. The frozen pellets may comprise more than one juice, as illustrated in the examples below. For purposes of this invention, the part of the juice added that defines the content of juice in the composition is the soluble juice solids, which are obtained from the juice. These soluble juice solids may be added to the composition by the addition of natural juice or through the the addition of juice concentrate. In most cases the soluble juice solids are added to the composition by using a juice concentrate. For purposes of this invention, the amount of soluble juice solids present in the composition, and the pellets made from the composition, is the measure of the juice present. Moreover, as described below, the amount of soluble juice solids in the composition, and the pellets made therefrom, is described herein by the weight equivalents of soluble juice solids present in the composition relative to the soluble juice solids present in a single strength juice.

Although the exemplary formulations in the Examples section below are for frozen pellets having a fruit flavor and made with fruit juices or juice concentrate (both of which will be referred to as adding fruit juice), it is recognized that the frozen pellets of the invention may include frozen pellets made with vegetable juices. The flavoring may also be a vegetable flavoring or a non-vegetable flavoring.

Food products, particularly beverages, are commonly classified by a percentage of juice. For example, many juice beverages are labeled as “100% juice”. Because the food product commonly uses juice concentrate, the percentage of juice in the food product is calculated based on the single strength of that particular juice. More specifically, the percentage of juice is based on the amount of soluble solids in the single strength juice. Juices are commonly classified in terms of a Brix value, which describes the percentage of soluble solids in a juice. Thus the Brix value for single strength (SS) juice is lower than the Brix value of a concentrate of that juice. To determine the percent of juice in a composition, the following formula may be used:

$$Percent juice = \frac{Brix of concentrate}{Brix of SS juice} * Wt . \% of concentrate in composition \qquad ( 1 )$$

Because the formula above depends on the Brix level of the concentrate and the Brix level of the SS juice, the formula describes how much juice is in the composition.

If the desired percentage of juice is known, the formula may be manipulated in order to determine how much (weight percent) of any given juice concentrate should be used in the composition.

$$Wt \% of concentrate = Percent juice * \frac{Brix of SS juice}{Brix of concentrate} \qquad ( 2 )$$

The above formulas are based on adding the juice concentrate to water to form a composition having a certain percentage of juice. The majority of the weight and volume in the composition used to form the frozen pellets is water and juice concentrate, but other ingredients (such as, for example, nonfat dry milk and a stabilizer) are included. For purposes of this invention, the measure of soluble juice solids in the frozen pellets is referred to as weight equivalents of juice, which is based on the soluble juice solids contained in the total composition used to form the frozen pellets. As used herein, weight equivalents of juice refers to the amount of soluble juice solids present in a composition, where 100 weight equivalents would be that amount of soluble juice solids in a single strength juice. A composition having 100 weight equivalents of juice will also be referred to as containing 100% juice or equivalent to 100% juice. The Examples section below includes calculations for weight equivalents of juice for particular foimulations.

In preferred aspects, the frozen pellets contain a significant amount of juice. In some embodiments, the frozen pellets comprise at least 50 weight equivalents of juice (i.e. equivalent to 50% juice). In some embodiments, the frozen pellets comprise about 100 weight equivalents of juice (i.e. equivalent to 100% juice). In other embodiments, the frozen pellets comprise over 100 weight equivalents of juice.

From a health perspective, it is desirable for the frozen pellets to contain a high level of juice—for example between 50 and 100 weight equivalents of juice. However, as the weight equivalents of juice increases in the composition used to foam the frozen pellets, the soluble solids in the composition also increases. Higher amounts of soluble solids may lead to poor pellet quality, such as for example, clumping of the pellets (i.e. loss of free flowing feature). Therefore, in some preferred aspects it may be desirable to use juices having a lower Brix level (i.e. lower amount of soluble solids). The use of juices having relatively lower levels of soluble solids will allow a composition to contain high levels of juice, while still providing acceptable pellet quality.

For example, in some embodiments, the frozen pellets may be formed from a composition using more than one type of juice concentrate, and in some cases, more than two types of juice concentrate. In those cases, the second (and if applicable, third, fourth, etc.) juice concentrate often is used to provide sweetness to the composition, while providing a minor flavor component, since the first juice concentrate provides the majority of the flavor. Thus, the secondary juice has a flavor that is less than a flavor of the first juice concentrate. The most commonly used juices for providing sweetness with low flavor are white grape juice, apple juice and pear juice. However, for the frozen pellets, white grape juice is not as desirable as apple juice and pear juice due to a higher amount of soluble solids, relative to apple juice and pear juice. Single strength white grape juice has a Brix value of 16.0, while the Brix values of apple juice and pear juice are equal to 11.5 and 12.0, respectively. Thus, in preferred aspects, the secondary juice in the composition has a Brix value less than 13.0, and more preferably, less than 12.0. In the Examples section below, the strawberry pellets, for example, use strawberry juice concentrate as the main juice, and apple juice and pear juice as the secondary juices. Although many other juices have a Brix value less than 12.0, some of these juices (for example, carrot juice) have strong flavor. In some preferred aspects, apple juice and pear juice are used as the secondary juices to provide an acceptable amount of soluble solids and a low flavor level.

As stated above, products having high juice content, such as the frozen pellets described herein, may be offered as a nutritional product due to significant juice content, particularly as compared to other products which may be fruit flavored, but often contain minimal, if any juice. However, frozen pellets having a higher percentage of juice typically contain more sugar or a higher amount of solids, as compared to a lower percent juice product, and thus have a lower freezing point caused by the high sugar content or higher amount of solids. A lower freezing point typically correlates to a lower melting point and/or higher melting rate. This results in undesirable melting and clumping.

Surprisingly, as described herein, the use of a multipart stabilizer together with a high juice content results in pellets that are free flowing at temperatures less than about −4° F. (about −20° C.), while having a taste and mouth feel similar to sherbet. As described in detail below, the stabilizer is used in combination with other ingredients to increase the melting point and/or decrease the melting rate of the frozen pellets. For purposes of this disclosure, the melting point is determined by a differential scanning calorimetry (DSC) test that is described in the Examples section below. For purposes of this invention, the melting point is the onset of the melting peak. For purposes of this invention, melting rate is determined by a test which measures the weight of product melted, as a function of time, at about 21° C. (ambient temperature).

In preferred embodiments, the frozen pellets also comprise milk or other dairy ingredients that improve the creamy taste and mouth feel of the pellets. The dairy may be used, in part, to provide milk solids, fat, and protein to the frozen pellets. The milk utilized may include whole milk, skim milk, 1% milk, 2% milk, condensed milk, non-fat milk, buttermilk, and mixtures thereof. In some embodiments, the frozen pellets include a nonfat dry milk comprised of milk protein and other milk solids. In some embodiments, the nonfat dry milk is between about 2 and about 6 weight percent of the composition. A cream fluid including, but not limited to, heavy cream, light cream, regular cream, and half and half may also be used in the pellets. In preferred aspects, a heavy cream is used to add fat to the composition, which contributes to the rich, creamy taste and mouth feel of the frozen pellets. It is also believed that the interaction between components of the stabilizer and fat from the cream may contribute to stability of the pellets. In some embodiments, the heavy cream is between about 1 and about 3 weight percent of the composition.

The milk portion of the frozen pellets may be described in terms of milk solids, which contribute to a creamy taste and mouth feel of the pellets. In some embodiments, the frozen pellets may have about 2 to about 5 weight percent of milk solids. The milk solids in the frozen pellets may include milkfat and nonfat milk derived solids. Interaction between the milk solids and the components of the stabilizer may also contribute to stability of the pellets. As stated above, the frozen pellets may include a heavy cream which includes milkfat. In some embodiments, the milkfat is between approximately 1 and 2 weight percent of the composition used to form the frozen pellets. The frozen pellets may include a nonfat drymilk which includes nonfat milk derived solids. In some embodiments, the nonfat milk derived solids content is at least one percent.

The frozen pellets include a multipart stabilizer that contributes to the viscosity of the composition used to make the pellets, as well as to mouth feel, and stability of the pellets once formed. The stabilizer functions, in part, to decrease the melting rate of the frozen pellets, as well as to control water migration as the frozen pellets approach the melting point. The stabilizer may comprise approximately 0.2 to 2.0 weight percent of the composition used to form the frozen pellets. The stabilizer may be included in a package that includes inactive ingredients. In the Examples section below, a stabilizer package may include the stabilizer components and inactive ingredients. The inactive ingredients should not be considered when determining the amount of stabilizer added to the composition. For example, modified food starch may be included in the stabilizer package, but at the levels in the Examples below, the food starch may, in large part, be a dispersing aid and it does not provide a significant stabilizing effect. Therefore, in the Examples below, modified food starch is not a stabilizer.

The multipart stabilizer acts as a gelling agent and a viscosifying agent in the composition used to form the frozen pellets. As used herein, viscosifying agent refers to food additives used to thicken the composition that forms the pellets. As used herein, gelling agent refers to food additives that are used to thicken the composition primarily by formation of a gel. It is recognized that many gelling agents are also thickening agents. It is believed that the gelling and viscosifying properties of the stabilizer act, among other things, to decrease the melting rate of the frozen pellets. Preferably the stabilizer may also act to minimize water available at the surface of the pellet, which may lead to clumping of the pellets and a loss of flowability. It is recognized that any of the components of the multipart stabilizer may have at least one of the functions described above—gelling, viscosifying, and controlling water retention or migration.

The multipart stabilizer may include hydrocolloids, such as, but not limited to, gelatin, citrus fiber, food starch and modified food starch, carrageenans, alginates, gellan gum, xanthan gum, microcrystalline cellulose gum and derivatives, locust bean gum, gum tragacanth, gum karaya, gum Arabic, gum ghatti, cellulose gum and derivates, pectin, guar gum, and tara gum. The hydrocolloids may be used to control water migration in the pellets, which prevents or limits a presence of water on the surface of the pellets. Water on the surface of pellets could undesirably lead to clumping of the pellets. Gums may also enhance the stability and/or mouth feel of the frozen pellets by providing viscosity and body to the composition used to form the pellets.

In some embodiments, one or more of carrageenan, locust bean gum, and guar gum are included in the multipart stabilizer. Carrageenan refers to a family of food grade polysaccharides obtained from red seaweeds, and includes extracts high in iota, kappa, and lambda carrageenan. Carrageenans are gelling agents and/or viscosifying agents, depending on the type of carrageenan used and the processing conditions. In preferred aspects, the multipart stabilizer uses kappa carrageenan. Carrageenan in the frozen pellets adds viscosity and stability to the pellets by retaining water in the frozen pellets and minimizing water migration to the surface of the pellets. Locust bean gum and guar gum are both galactomannans, which is a type of polysaccharide. Although locust bean gum (also known as carob bean gum) is not self-gelling, it forms a gel in combination with other ingredients and results in an increased viscosity when used in the frozen pellets. Guar gum may similarly be used to increase viscosity of the composition used to form the frozen pellets.

Some of the gums may exhibit a synergistic effect in the presence of other hydrocolloids or other components. For example, the following pairs of gums exhibit gelling or viscosity synergy. Locust bean gum and kappa-carrageenan form a strong gel together, even though individually locust bean gum typically does not gel the composition appreciably. Locust bean gum and xanthan gum have viscosity synergy, as do guar gum and xanthan gum. Viscosity synergy means that if the pairs of gums are used together in the composition, the combined increase in viscosity is greater than a sum of the viscosity increase by each of the gums individually. This viscosity synergy may result in the formation of a viscoelastic gel that in some regards acts as a solid under low shear conditions, meaning that the gel must experience a sufficient amount of stress to initiate flow. This shear stress that initiates flow is sometimes referred to as the yield stress. The hydrocolloids described herein may exhibit synergy with other ingredients, such as, for example, synergy between carrageenan and milk proteins.

In some preferred aspects, the stabilizer includes a gelling type sodium alginate. White not wanting to be bound by theory, it is believed that a viscosifying sodium alignate may also be utilized to provide additional viscosity to the composition and/or or replace viscosifying agents like guar gum. The gelling type sodium alginate, in particular, reacts with calcium to form a gel. In those embodiments in which milk or other dairy ingredients containing calcium are used, sodium alginate forms a gel by reacting with the calcium in the composition.

As stated above, certain types of food starch and modified food starch are hydrocolloids. However, in addition to being dependent on the type of food starch and the modifications to the food starch, the hydrocolloid functionality is dependent on the use level of the food starch in the composition. Stabilizer packages described herein may include modified food starch (see Examples section below). However, at those particular use levels, the modified food starch is expected to contribute minimal, if any, stabilizing effect to the composition. As such the modified food starch is not considered an active ingredient in the stabilizer package.

As described above, in preferred embodiments, the frozen pellets contain milkfat and/or other milk solids, which may be derived from, for example, a heavy cream and nonfat dry milk. In some embodiments, the frozen pellets may have about 2 to about 5 weight percent of milk solids. If the frozen pellets contained a significantly higher percent of milk solids, it is believed that the reaction between sodium alginate and calcium from the milk solids would create a gel having too high a viscosity. As discussed below, the viscosity of the composition used to form the frozen pellets may become too high such that proccessability of the frozen pellets is more difficult. Thus an amount of sodium alginate in the stabilizer is preferably optimized based on the amount of calcium in the composition and a desired viscosity of the composition, as well as a ratio of gelling alginate and viscosifying alginate used.

In some embodiments, the multipart stabilizer includes at least two components. In other embodiments, the multipart stabilizer includes at least three components. In yet other embodiments, the multipart stabilizer includes at least four components. The various components contribute to increase the viscosity, form a gel and minimize water migration in the pellets, which contribute to stable frozen pellets. It is believed that some or all of the components in the stabilizer perform multiple functions, which additionally may include contributing to a satisfactory taste and mouth feel of the frozen pellets.

In some embodiments, the stabilizer is a four component stabilizer having carrageenan, locust bean gum, sodium alginate, and guar gum. An appropriate range of the stabilizer in the composition is between approximately 0.2 and 2.0 weight percent. In some embodiments, the stabilizer in the composition is between approximately 0.3 and 1.0 weight percent. In some embodiments, the stabilizer is approximately 0.6 weight percent of the composition. In some embodiments, the amount of each stabilizer component in the composition is about 0.05 to about 0.4 weight percent of sodium alginate, about 0.05 to about 0.4 weight percent of carrageenan, about 0.05 to about 0.4 weight percent of locust bean gum, and about 0.01 to about 0.3 weight percent of guar gum. It is recognized that a number of hydrocolloids, including, but not limited to, viscosifying sodium alginate and xanthan gum, may used in place of guar gum.

As an alternative to the four component stabilizer described immediately above, the frozen pellets made with juice may use the stabilizer described below in reference to the frozen pellets made with yogurt. In those embodiments, the four component stabilizer includes citrus fiber, xanthan gum, guar gum, and modified cellulose.

The viscosity of the composition or mix used to form the frozen pellets affects features of the pellets that are produced, such as the size and shape of the pellets, while also affecting the taste and mouth feel of the frozen pellets. The multipart stabilizer results in pellets having excellent mouth feel and taste, together with reduced melting rate and clumping of the pellets. The amount of stabilizer in the composition may be adjusted to achieve the desired stability and quality of the pellets, as well as the desired mouth feel. In some embodiments, the viscosity of the composition is between about 200 and 600 centipoise (cP). In some embodiments, the viscosity of the composition is between about 250 and 450 centipoise (cP). In some embodiments, the viscosity of the composition is between about 300 and 350 centipoise (cP). For purposes of this disclosure and this invention, viscosity is measured at approximately 23° C. or approximately room temperature, unless a different temperature is specifically provided, using a Brookfield rotational viscometer fitted with a LV3 spindle and measured at 50 rpm, unless a different rpm is specifically provided.

In some embodiments, the stabilizer is a three component or three part stabilizer having carrageenan, locust bean gum and sodium alginate. In some embodiments, the stabilizer is a two component stabilizer having locust bean gum and carrageenan. In some embodiments, a two component stabilizer includes xanthan gum and guar gum. In other embodiments, a two component stabilizer includes citrus fiber and xanthan gum.

Depending in part on the components in the stabilizer, in some embodiments, the viscosity of the composition used to form the pellets is less than 200 cP. In some embodiments, the viscosity of the composition is less than 150 cP; in other embodiments, less than 100 cP; and in yet other embodiments, less than 75 cP.

As described in further detail below, the pellets may be formed by cryogenic freezing, using for example, a cryogran manufactured by Air Liquide. The composition is poured into the cryogran and comes into contact with liquid nitrogen. If the viscosity is not high enough, the pellets may be too small to provide the desired mouth feel and sensory experience. Moreover, a particular range of the pellet size may be preferred from an aesthetic perspective, particularly for children. Thus by controlling the viscosity it is also possible to control the size and shape of the pellets. On the other hand, from a proccessability standpoint, it is undesirable if the composition or mix has too high a viscosity since the composition becomes difficult to pump and the production rate of the pellets is reduced. The viscosity ranges, as well as the formulas disclosed in the Examples below, result in frozen pellets that are stable, have a desirable size and shape, and a creamy mouth feel.

The frozen pellets may include inulin or other types of fructo-oligosaccharide fibers that belong to the fructan group of oligo- and polysaccharides. They are composed of linear chains of fructose units linked by β2-1 and/or β2-6 bonds and are generally terminated by a glucose unit. Fructo-oligosaccharides may promote the growth of beneficial Bifidobacteria in the lower gut and may help increase the absorption of dietary calcium. While not being bound by any theory, the addition of inulin and/or fructo-oligosaccharide fibers may increase viscosity of the composition and improve stability of the pellets, while also improving the mouth feel and creaminess of the frozen pellets. It is believed that the inulin contributes to a decrease in melting rate of the frozen pellets. In preferred aspects, a long-chain inulin (above about 20 microns) is used in the composition. In some embodiments, the frozen pellets include about 1 to about 5 weight percent of inulin or other fructo-oligosaccharides. In some embodiments, the frozen pellets include about 1 to 3 weight percent of inulin.

As described above, the frozen pellets having a significant amount of juice, and thus contain sugar from the juice. The frozen pellets may also include a sweetener, which contributes to the flavor and sweetness of the frozen beverage. The presence and amount of sweetener may vary, in part, with the desired flavor of the frozen pellets, the flavoring used, consumer preference, desired caloric content, the type of juice and the amount of juice in the composition. If a high intensity sweetener is used, the amount of sweetener in the composition may be less. In some aspects, the frozen pellets include up to about five weight percent of a sweetener.

The sweetener can be nutritive or nonnutritive. Examples of sweeteners for use in the present invention include trehalose, sucrose, sucralose, maltodextrin, corn syrup, corn syrup solids, high maltose syrups, sugar solids, fructose, lactose, dextrose, fructo-oligosaccharides such as acesulfame potassium, neotame, saccharin, aspartame, high fructose corn syrup, sorbitol, mannitol, xylitol, erythritol, maltitol, isomaltitol, lactitol, monatin, rebiana and mixtures thereof.

Sucralose is a high-intensity sugar substitute, which is sold under the name Splenda™. It is non-caloric and about 600 times sweeter than sucrose (white table sugar), although it can vary from 320 to 1,000 times sweeter, depending on the food application. The white crystalline powder tastes like sugar, but is more intense in its sweetness. Other high intensity sugar substitutes include aspartame, saccharin, acesulfame potassium, and neotame, monatin and rebiana. In some aspects, the frozen pellets include about 0.005 to about 0.10 weight percent of sucralose.

It is recognized that a combination of more than one sweetener may be used in the frozen pellets. For example, a combination of trehalose and sucralose, or a mixture of trehalose, corn syrup, and sucralose, may be used as a sweetener. In other embodiments, maltodextrin, or a combination of maltodextrin and sugar solids (e.g., sucrose), or a combination of maltodextrin, sugar solids, and sucralose may be used. Maltodextrins are mixtures of glucose polymers produced by the controlled depolymerization of corn starch. They are most often categorized by dextrose equivalent. In yet other embodiments, a mixture of sucralose, sugar, corn syrup and corn syrup solids are used, or a mixture of sucralose, corn syrup solids, corn syrup, inulin, and maltodextrin are used.

The frozen pellets may include one or more flavorings, which may be artificial, natural or a combination of both. The amount of the flavoring may depend, in part, on the flavoring itself, the type and amount of juice in the composition, sweetener content in the composition, and consumer preference. In some embodiments, the frozen pellets have about 0.1 to about 0.6 weight percent of a flavoring. Suitable flavorings include, but are not limited to, natural strawberry, natural banana, citrus fruit flavors, other non-citrus fruit flavors, spices, herbs, botanicals, chocolate, cocoa, chocolate liquor, coffee, flavorings obtained from vanilla beans, nut extracts, liqueurs and liqueur extracts, fruit brandy, distillates, aromatic chemicals, imitation flavors, concentrates, extracts or essences of any of the same. Flavorings are available commercially from, e.g., Cargill inc. (Wayzata, Minn.); Rhodia USA (Cranbury, N.J.); IFF (South Brunswick, N.J.); Wild Flavors, Inc. (Erlanger, Ky.); Silesia Flavors, Inc. (Hoffman Estates, Ill.), Chr. Hansen (Milkwaukee, Wis.), and Firmenisch (Princeton, N.J.).

The frozen pellets may include food grade colorants, either natural or artificial. The type and amount of colorant selected may depend, in part, on the type of frozen pellets and consumer preference. The colorant may include synthetic colors (e.g., azo dyes, triphenylmethanes, xanthenes, quinines, and indigoids), caramel color, titanium dioxide, red #3, red #40, blue #1, and yellow #5. Natural coloring agents such as beet juice (beetred), carmine, curcumin, lutein, carrot juice, berry juices, spice extractives (turmeric, annatto and/or paprika), and carotenoids may also be used. In some embodiments, the frozen pellets include about 0.0001 to about 0.01 weight percent of a colorant. Colorants are available from, e.g., Wild Flavors, Inc. (Erlanger, Ky.), McCormick Flavors (Hunt Valley, Md.), CHR Hansen (Milwaukee, Wis.), RFI Ingredients (Blauvelt, N.Y.), and Warner-Jenkinson (St. Louis, Mo.).

Other Optional Ingredients for Frozen Pellets Made with Juice

As described above, the frozen pellets include a multipart stabilizer that acts in part as a gelling agent and a viscosifying agent to foam stable pellets. Some of the exemplary components of the stabilizer may also act as emulsifiers, such as, for example, gum arabic and some modified food starches. The frozen pellets may include other emulsifiers not disclosed above.

Exemplary food grade emulsifiers include, but are not limited to, distilled monoglycerides, mono- and diglycerides, diacetyl tartaric acid esters of mono- and diglycerides (DATEM), lecithin, emulsifying starches (e.g., octenylsuccinate anhydride starch), modified lecithin, polysorbate 60 or 80, sodium stearyl lactylate, propylene glycol monostearate, succinylated mono- and diglycerides, acetylated mono- and diglycerides, propylene glycol mono- and diesters of fatty acids, polyglycerol esters of fatty acids, lactylic esters of fatty acids, glyceryl monosterate, propylene glycol monopalmitate, glycerol lactopalmitate and glycerol lactostearate, and mixtures thereof. Emulsifiers are available commercially through, e.g., Central Soya (Fort Wayne, Ind.); and Danisco (Copenhagen, Denmark).

As also described above, the frozen pellets may contain milk fat. In some embodiments, the milk fat may be from a cream fluid, such as, for example, a heavy cream. Other fats may be used in the frozen pellets in addition to or as an alternative to milk fat. As disclosed herein, “fat” includes both liquid oils and solid or semi-solid fats. Fats may contribute to a creamy mouth feel. Suitable fats include, but are not limited to, vegetable oils such as cotton seed oil, soybean oil, corn oil, sunflower oil, palm oil, canola oil, palm kernel oil, peanut oil, MCT oil, rice oil, safflower oil, coconut oil, rape seed oil, and their mid- and high-oleic counterparts; or any combination thereof. The frozen pellets may also include partially or fully hydrogenated versions of any of the oils listed above. Fats and oils are available commercially from, e.g., Cargill, Inc. (Wayzata, Minn.), Fuji Vegetable Oil (White Plains, N.Y.), ADM (Decatur, Ill.), and Loders-Croklaan (Channahon, Ill.).

Fiber sources, in addition to inulin or other fructo-oligosaccharides, may also be included in the frozen pellets. Both soluble and insoluble fiber sources can be used to increase total dietary fiber content; to add mouthfeel, texture, and body; to enhance flavor; and to replace fat (e.g. as a fat mimetic). Examples of fiber sources include arabinogalactan, pectin, beta glucan, maltodextrin, resistant starch, psyllium, CMC, microcrystalline cellulose, alginate, gum Arabic, partially hydrolyzed guar gum, locust bean gum, carrageenan, xanthan gum, and oat fibers.

Proteins or peptides may be included in the frozen pellets for nutritive purposes and/or for their contribution to the consistency, whipping property, smoothness, and mouth feel. As described previously, the composition may include milk, such as non-fat dry milk and/or cream, both of which may supply protein to the composition. Additional proteins, as well as peptides, may be added to supplement the protein from the milk. Typical proteins include caseins, soy proteins (e.g., soy protein isolate or hydrolysate), albumin, milk proteins, whey protein, rice protein, wheat protein, oat protein, and mixtures thereof. Protein hydrolysates may also be used. Proteins are available from, e.g., Fonterra (New Zealand); Land O'Lakes (St. Paul, Minn.); Cargill, Inc. (Wayzata, Minn.); and Erie Foods International Inc. (Erie, Ill.).

Preservatives may be included in the frozen pellets. Examples include, but are not limited to, potassium sorbate, calcium sorbate, and sodium benzoate. Masking agents can be included to mask artificial sweeteners or off-flavors, such as grassy, beany, or chalky flavors found in some nutritional ingredients. Acidulants can provide sharpness and bite, and also contribute to preservation. Citric, malic, fumaric, ascorbic, lactic, phosphoric, and tartaric acid can be used as acidulants. Acidulants are available from e.g., Cargill, Inc. (Wayzata, Minn.) and ADM (Decatur, Ill.).

Frozen pellets may also contain one or more nutritive and/or health additives, e.g., to promote weight gain or loss, cardiovascular health, pediatric health, geriatric health, women's health, etc. Suitable examples of nutritive and/or health additives, include proteins (e.g., as described above); fats; carboyhydrates; triglycerides; fiber (e.g., soy fiber); amino acids (e.g., histidine, isoleucine, leucine, lysine, methionine, phenylalanine, threonine, tryptophan, valine, alanine, arginine, aspartic acid, cystine, glutamic acid, glycine, proline, serine, tyrosine); L-carnitine, taurine, m-inositol; nucleic acids; fatty acids (omega-3 fatty acids, such as EPA and DHA; polyunsaturated, monounsaturated, and saturated fatty acids, such as linolenic acid, alpha-linolenic, caprylic acid, capric acid, lauric acid, myristic acid, palmitic acid, stearic acid, oleic acid, and arachidic acid); plant phytosterols and plant phytostanols; isoflavones (e.g., daidzein, genistein, glycitein, daidzin, genistin, glycitin, 6″-O-acetyldaidzin, 6″-O-acetylgenistin, 6″-O-acetylglycitin, 6″-O-malonyldaidzin, 6″-O-malonylgenistin, and 6″-O-malonylglycitin); green tea extracts; vitamins (e.g., vitamins A, D, E, K, C, folic acid, thiamin, riboflavin, vitamins B6 and B12, niacin, choline, biotin, panthothenic acid); beta-carotene; phylloquinone; niacinamide; minerals (sodium, potassium, chloride, calcium, phosphorus, magnesium, iodine, manganese, copper, zinc, iron, selenium, chromium, molybdenum); glucosamine sulfate; chondroitin sulfate; hyaluronic acid; s-adenosyl methionine; milk thistle; dandelion, burdock, ginseng, ginger, ginko bilboa, caffeine, guarana, inulin, zeaxanthin, rosmarinic acid, lycopene, lutein, grape extracts, flax seed, and salts, including salts of the compounds described previously; and derivatives of the compounds described previously. Vitamins and minerals are available from e.g., Roche Vitamins, Inc. (Parsippany, N.J.); phytonutrients and carbohydrates are available from Cargill, Inc. (Wayzata, Minn.).

Examples of additional optional ingredients include, but are not limited to, buffers, cloudifiers, masking agents, foaming agents, antifoaming agents and nutritive additives as known to one of skill in the art.

Preparation of Frozen Pellets Made with Juice

To prepare the frozen pellets described herein, the various ingredients are generally mixed in the appropriate amounts and heated, if necessary, to aid in dispersion and solubilization of the ingredients. In some embodiments, some of the dry ingredients, such as, for example, nonfat dry milk, inulin and sucralose, are added together and then hydrated in water to form a preliminary batch. The other ingredients, which may include the juice or juices, cream and stabilizer, are added to the preliminary batch and then blended well. The composition or mix may then be pasteurized by FDA approved methods in either continuous flow, multi-stage or batch methods. Flavorings and/or sweeteners may be added prior to heating, after heating, or after cooling, particularly if the flavorings or sweeteners are volatile or heat-sensitive.

In some cases, the mixture may then be cooled to a temperature from about two degrees Celsius (2° C.) to about ten degrees Celsius (10° C.). The cooled composition may remain at the cooled temperature for an aging period, for example, about four hours to about 24 hours. Aging may contribute to a favorable and homogeneous distribution of the stabilizer.

The composition may next be frozen to form the pellets. In preferred embodiments, the frozen pellets are formed by cryogenically freezing the mix. For purposes of this disclosure, cryogenic freezing occurs at temperatures below 120 degrees Kelvin. In some embodiments, the pellets are formed by dripping the composition into a bed of liquid nitrogen contained within a cryogenic granulator. Upon impact with the liquid nitrogen, or a similar liquid, the mix becomes instantly frozen into small, bead-like pellets. In preferred embodiments, the pellets are generally spherical in shape; however, it is recognized that alternative shaped pellets may be formed.

After cryogenic freezing, the pellets may be hardened or tempered at a temperature ranging between about −10° C. and about −50° C. Hardening or tempering may take place for any period of time, e.g. about 1 hr. to about 1 week, or longer. Aging and/or tempering can bring the pellets into a more stable condition given temperature fluctuations during distribution (e.g., favorable melting rate, favorable melting temperature).

The process steps disclosed above may be completed at one location and without disruption. Alternatively, the process may include periods of inactivity. The in-process composition is preferably stored either in a refrigerator or a freezer, during any period of inactivity. The various steps may be performed at various locations, provided that necessary shipping precautions are followed (for example, maintaining the composition at or below a particular temperature). The composition may, for example, be formed at one location and shipped to another location for cryogenic freezing. As another example, the dry ingredients of the composition may be blended together and then stored or shipped, and the other ingredients may be added to the dry batch and blended at a later date.

Any of the compositions, either the composition used to form the frozen pellets or a preliminary or intermediary composition, may be provided as an article of manufacture. For example, the compositions may be packaged in appropriate containers (for example, drums, pouches, tubs, totes, bags, buckets, cartons) for easy transport to points of sale and preparation and for easy pouring and/or mixing. The article of manufacture may contain optional objects, such as utensils, containers for mixing or other optional ingredients.

Articles of manufacture may include instructions for preparing frozen pellets made with juice. Such instructions may include, for example, instructions for blending the various dry ingredients together to form the preliminary batch. In the scenario in which the dry ingredients are shipped with the other ingredients, the instructions may include instructions on combining the non-dry ingredients (i.e. juice, cream, etc) into the preliminary batch. The instructions may include directions for the preparation of a mixture having the appropriate ranges by weight. The instructions may provide instructions related to one or more methods for forming the frozen pellets and instructions for packaging the frozen pellets.

Articles of manufacture may also include instructions for packaging the frozen pellets made with juice with another pellet product to create a frozen food product. For example, as described below, the frozen pellets made with juice may be packaged with frozen pellets made with yogurt.

Frozen Food Product Containing Frozen Pellets Made with Juice

The frozen pellets made with juice, as described above, may be offered, for example, as a snack type frozen food product and/or a dessert type frozen food product. In both cases, the frozen pellets may be offered as a nutritional food product containing a high level of juice. In some embodiments, the frozen food product is made up of all frozen pellets made with juice. The frozen pellets made with juice may be the same flavor. Alternatively the frozen food product may contain a mixture or blend of different flavors of frozen pellets made with juice.

In some embodiments, the frozen food product may include frozen pellets made with juice in combination with a second type of frozen pellets. In an exemplary embodiment, the second type of frozen pellets is frozen pellets made with yogurt, which are described in detail below. A frozen food product containing a blend of pellets made with juice and pellets made with yogurt provides a great tasting, nutritional food product. For example, the pellets made with juice may be strawberry and the pellets made with yogurt may have a vanilla flavor. The combination of the two pellets results in a frozen food product having flavor similar to a smoothie. In one aspect, equal amounts of the pellets made with juice and pellets made with yogurt are used, such that the product is a 1:1 blend. It is recognized that any ratio of blends may be used in the frozen food product. Although the frozen pellets made with juice are specifically disclosed as being usable with frozen pellets made with yogurt, it is recognized that the frozen pellets made with juice may be blended with other types of frozen products as desired to achieve a particular taste or a product having a particular nutritional value.

Frozen Pellets Made with Yogurt

Similar to the frozen pellets made with juice, the frozen pellets made with yogurt are formed from a composition or a mix that is cryogenically frozen using the same process as described above. The pellets made with yogurt may have any shape, size, volume, surface area and color. In some embodiments, the pellets made with yogurt may be similar in size and shape to the pellets made with juice. In other embodiments it may be desirable to make the pellets made with yogurt intentionally larger or smaller than the pellets made with juice.

In some embodiments, the frozen pellets made with yogurt include nonfat milk blend, yogurt, and a multipart stabilizer. As described further below, the composition used to form the frozen pellets made with yogurt may be formed by combining a nonfat milk blend with a cultured yogurt. In preferred embodiments, the composition includes at least 3 weight percent of cultured yogurt. In an exemplary embodiment, the nonfat milk blend is approximately 95 weight percent of the composition and the cultured yogurt is approximately 5 weight percent. The frozen pellets made with yogurt may include a flavoring, such as, for example, a vanilla flavoring. The flavoring may be added to the composition when the nonfat milk blend and the cultured yogurt are combined. Alternatively the flavoring may be added to one of the two blends prior to combining. In an exemplary embodiment, the composition used to form the flavored frozen pellets is about 94.7 weight percent of nonfat milk blend, about 5 weight percent of cultured yogurt, and about 0.3 weight percent of vanilla flavoring.

The nonfat milk blend may include milk fluids, sucrose, water, nonfat dry milk, sucralose, corn syrup and a stabilizer. The milk blend for the cultured yogurt may be formed by first combining milk fluids, granulated sugar, water, nonfat dry milk and a yogurt stabilizer to form the preliminary blend. In one example, the milk fluids in the nonfat milk blend and the cultured yogurt are whole milk, but other types of milk, including, but not limited to, 1% milk, 2% milk, condensed milk, non-fat milk, buttermilk and mixtures thereof, may be used in one or both of the nonfat milk blend and the cultured yogurt.

Specifically, for the milk blend having the cultured yogurt, once the preliminary blend is formed, the preliminary blend is pasteurized at about 190 to 195° F. for about one minute and then homogenized in two stages at 1500 psi and 500 psi. The preliminary blend is then cooled to 105° F., at which point a frozen starter culture mixture at about 0.01-0.02% may be added to the preliminary blend to form the cultured yogurt. After the cultures are added to the preliminary blend, the yogurt is incubated at about 105° F. for approximately five or six hours and/or until the pH level is about 4.5, which indicates that the cultures are active.

The nonfat milk blend is also typically pasteurized at some point. Once the cultured yogurt is incubated, the two blends of the nonfat milk blend and the cultured yogurt are mixed together to form the composition, which may then be processed through the cryogran to form the frozen pellets made with yogurt.

In some embodiments, the multipart stabilizer used in the pellets made with yogurt is a different stabilizer than the preferred stabilizer used in the frozen pellets made with juice. In preferred aspects, the multipart stabilizer used in the pellets made with juice included sodium alginate, which forms a gel with calcium from the milk in the composition. The stabilizer used in the pellets made with yogurt preferably does not contain sodium alginate due to a higher content of milk in the composition. This composition for the pellets made with yogurt contains too much calcium to effectively use sodium alginate.

In preferred aspects, the stabilizer used in the pellets made with yogurt includes citrus fiber, xanthan gum, guar gum and modified cellulose. The stabilizer package may also include salt and modified food starch. It is believed that the combination of citrus fiber, xanthan gum, guar gum and modified cellulose contributes to increasing a viscosity of the composition used to foam the frozen pellets. In particular, the combination of guar gum and xanthan gum is beneficial since these two gums have viscosity synergy, and a significant yield stress. Moreover, the xanthan gum has a high yield stress such that it exhibits gel like properties. In preferred aspects the composition used to make the frozen pellets made with yogurt has a viscosity in the range described above for the frozen pellets made with juice.

The cultured yogurt may also include a stabilizer to prevent separation of the yogurt prior to mixing and to allow storage of the cultured yogurt throughout processing. The yogurt stabilizer is not intended to impart stability to the frozen pellets. The yogurt stabilizer may be added to the yogurt blend before or after culturing.

Any of the other optional ingredients described above in reference to the frozen pellets made with juice may also be used in the frozen pellets made with yogurt. For example, nutritive and/or health additives may be added as needed or as desired. Moreover, other optional ingredients may be used to result in pellets having a particular viscosity, consistency, taste, mouth feel and/or stability.

The invention will be further described in the following examples, which do not limit the scope of the invention described in the claims.

### EXAMPLES

### Example 1

### Formulation and Preparation of Strawberry Pellets

Strawberry pellets having the formulation shown in Table 1 were made using the procedure described below.

TABLE 1
Strawberry Pellets, equivalent to 100% juice

| | % | |
|---|---|---|
| Ingredient | (wt/wt) | wt (g) |
| Water | 75.990 | 6,079.20 |
| Strawberry Juice Concentrate, 65 | 6.154 | 492.32 |
| Brix | | |
| Pear Juice Concentrate, 70 Brix | 4.286 | 342.88 |
| Apple Juice Concentrate, 70 Brix | 4.109 | 328.72 |
| Nonfat Dry Milk | 4.000 | 320.00 |
| Inulin, Oliggo-Fiber ® | 2.000 | 160.00 |
| Heavy Whipping Cream (36% fat) | 1.950 | 156.00 |
| Gel Stabilizer 1C | 0.619 | 49.50 |
| Modified Food Starch | 0.481 | 38.50 |
| Natural Flavor, Strawberry | 0.390 | 31.20 |
| Sucralose | 0.019 | 1.52 |
| FD&C Red 40 | 0.002 | 0.16 |
| | 100.000 | 8,000.00 |

The strawberry pellets shown in Table 1 contain soluble juice solids equivalent to 100% juice (i.e. 100 weight equivalents of juice). In order to calculate the weight equivalents of juice, the following formula (as described above) is used:

$$Weight equivalents of juice = \frac{Brix of concentrate}{Brix of SS juice} * Wt . \% of concentrate in composition \qquad ( 3 )$$

When more than one juice concentrate is used, the equation above is used for each juice concentrate to calculate the weight equivalents from each juice present in the composition. The total weight equivalents is the summation of the weight equivalents from each juice added. For the composition in Example 1:

$$Weight equivalents of Juice for Strawberry Pellets in Example 1 = {( \frac{65}{8} * 6.154 )}_{Strawberry} + {( \frac{70}{12} * 4.286 )}_{Pear} + {( \frac{70}{11.5} * 4.109 )}_{Apple} = 100.014 \qquad ( 4 )$$

In the composition for forming the strawberry pellets, approximately 50 of the 100 weight equivalents is from the strawberry juice concentrate, approximately 25 weight equivalents is from the pear juice concentrate; and approximately 25 weight equivalents is from the apple juice concentrate.

As shown in Table 1, the strawberry pellets contain other ingredients in addition to water and juice. As explained above, the amount of juice in the pellets is defined as the weight equivalents of juice. The strawberry pellets of Table 1 use a four component stabilizer that is described below under Example 4. The four component stabilizer in the pellets of Example 1 is part of Gel stabilizer package #1C, which includes modified food starch (inactive), guar gum, sodium alginate, locust bean gum and carrageenan. See Examples 3 and 4 below regarding evaluation of the stabilizer.

A viscosity of the composition used to form the strawberry pellets is approximately 310 cP.

Procedure for making the pellets: The dry ingredients are weighed and blended to disperse. In this example, the dry ingredients include the nonfat dry milk, inulin and sucralose. The dry blend ingredients are then hydrated with water. The appropriate amount of the heavy whipping cream is added to the mixture, followed by addition of the three juice concentrates. Next, the stabilizer is added to the mixture. The remaining ingredient added is the natural flavor, which, in this example, is strawberry. The mixture is then blended.

During the final blending, the mixture is preheated to 140° F. and homogenized using a two-stage homogenizer at 2000 psi during the first stage and at 500 psi during the second stage. The mixture is then heated to 190° F. and held for 90 seconds to pasteurize the mixture. The mixture is cooled to about 60 to about 70° F. and filled under aseptic conditions in two liter containers. The mixture is stored in a refrigerator for about 18 hours to chill to a temperature between 2 and 10° C. It is preferable to store the mixture for a few hours after filling to ensure adequate cooling.

When the mixture is taken out of the refrigerator, the container is agitated manually and shaken. The composition is then poured through a cryogenic granulator and into an Air Liquide Cryogran using liquid nitrogen. The cryogran is at a setting of approximately 80 (on a scale of 1 to 100), which controls a rate at which liquid nitrogen flows through the cryogran. Frozen pellets then exit the cryogran onto a conveyor belt. The frozen pellets are put into a container and are stored in a freezer at temperatures about equal to or less than −4° F.

Other formulations disclosed below are made using a similar procedure.

### Example 2

### Other Formulations of Frozen Pellets Made with Juice

TABLE 2
Banana Pellets, equivalent to 100% juice

| | % | |
|---|---|---|
| Ingredients | (wt/wt) | wt (g) |
| Water | 73.805 | 5,904.40 |
| Apple Juice Concentrate, 70 Brix | 8.215 | 657.20 |
| Pear Juice Concentrate, 70 Brix | 8.571 | 685.68 |
| Nonfat Dry Milk | 4.000 | 320.00 |
| Inulin, Oliggo-Fiber ® | 2.000 | 160.00 |
| Heavy Whipping Cream (36% fat) | 1.950 | 156.00 |
| Gel Stabilizer #1C | 0.619 | 49.50 |
| Modified Food Starch | 0.481 | 38.50 |
| Natural Flavor, Banana | 0.350 | 28.00 |
| Sucralose | 0.009 | 0.72 |
| | 100.000 | 8,000.0 |

$$Weight equivalents of Juice for Banana Pellets of Table 2 = {( \frac{70}{11.5} * 8.215 )}_{Apple} + {( \frac{70}{12} * 8.571 )}_{Pear} = 100.002 \qquad ( 5 )$$

Although not measured, it is believed that the viscosity of the composition used to form the banana pellets of Table 2 is approximately 300 cP.

TABLE 3
Orange Pellets, equivalent to 50% juice

| | % | |
|---|---|---|
| Ingredients | (wt/wt) | wt (g) |
| Water | 81.574 | 8,157.40 |
| Orange Juice Concentrate, 65 Brix | 9.077 | 907.70 |
| Nonfat Dry Milk | 4.000 | 400.00 |
| Inulin, Oliggo-Fiber ® | 2.000 | 200.00 |
| Heavy Whipping Cream | 1.950 | 195.00 |
| Gel Stabilizer #1C | 0.619 | 61.88 |
| Modified Food Starch | 0.481 | 48.12 |
| Natural Flavor, Orange | 0.165 | 16.50 |
| Color, FD&C Yellow 6, 1% Sol'n | 0.100 | 10.00 |
| Sucralose | 0.034 | 3.40 |
| | 100.000 | 10,000.00 |

$$Weight equivalents of Juice for Orange Pellets of Table 3 = {( \frac{65}{11.8} * 9.077 )}_{Orange} = 50.000 \qquad ( 6 )$$

Although not measured, it is believed that the viscosity of the composition used to form the orange pellets of Table 3 is approximately 225 to 250 cP.

The formulations disclosed above show frozen pellets having either about 50 weight equivalents of juice or 100 weight equivalents of juice. By increasing or decreasing the amount of juice concentrate in the formulation, the weight equivalents of juice may be increased or decreased. It is recognized that the frozen pellets may include formulations having less than 50 weight equivalents of juice and formulations having more than 100 weight equivalents of juice. In preferred embodiments, the frozen pellets have between approximately 50 and 100 weight equivalents of juice such that the frozen pellets are equivalent to products having 50 to 100 percent juice. Within this range of juice content, the frozen pellets of the invention have good pellet quality and stability, as well as a creamy frozen taste. Moreover, at this juice content, the frozen pellets may be offered as a nutritional product.

TABLE 4
Orange Juice, equivalent to 100% juice

| Ingredients | % | % solids |
|---|---|---|
| OJ conc (65 Bx) | 18.154 | 11.80 |
| Water | 79.831 | 0.000 |
| Inulin | 1.000 | 0.950 |
| Gel Stabilizer #2 | 0.505 | |
| Modified Food Starch | 0.495 | |
| Sucralose | 0.015 | 0.015 |
| Total | 100.000 | 13.685 |

$$Weight equivalents of Juice for Orange Juice Pellets of Table 4 = {( \frac{65}{11.8} * 18.154 )}_{Orange} = 100.001 \qquad ( 7 )$$

The orange juice pellets of Table 4 have 100 weight equivalents of juice. Thus, the amount of juice or the amount of soluble juice solids in the orange juice pellets of Table 4 is approximately the same as single strength orange juice.

The orange juice pellets include gel stabilizer package #2, which is discussed and shown below in Table 7 under Example 5. In the example formulation shown in Table 4 for orange juice pellets, the formulation does not include milk or other dairy ingredients. The combination of components in gel stabilizer package #2 is believed to limit water mobility by imparting a high yield stress. It is observed that the synergistic combination of guar gum and xanthan gum restricts melting more than some formulas made with gel stabilizer package #1. Gel stabilizer package #2 does not have the high calcium sensitivity of sodium alginate and may be used in formulations with and without dairy components. Several combinations of xanthan gum and other hydrocolloids may be used to achieve pellet stability. Pellets with stabilizer package GM exhibit clumping, likely due to the lower yield stress compared to xanthan gum alone or in combination with other hydrocolloids.

### Example 3

### Evaluation of Stabilizer Package Galactomannan (GM) in Frozen Pellets Made with Juice

Galactomannans are commonly used in sherbet type food products. An example is stabilizer package GM, which contains locust bean gum, guar gum and sugar which is shown in Table 5 below. It is noted that the sugar is not an active ingredient in the stabilizer package GM. When frozen pellets similar to those disclosed above, for example, strawberry pellets of Example 1, are made using stabilizer package GM as the stabilizer instead of Gel Stabilizer package #1C, the same quality of pellets are not produced. After a relatively short period of time (within a few weeks of cryogenically freezing), clumping is observed when the pellets made with stabilizer package GM are taken out of the freezer. As described below in reference to Example 4, in preferred embodiments, the frozen pellets include a stabilizer selected from the Gel Stabilizer package #1 series of stabilizer.

TABLE 5
Formulation of Stabilizer Package GM

| Component | Weight Percent |
|---|---|
| Locust Bean Gum | 33 |
| Guar Gum | 14 |
| Sugar | 53 |
| Stabilizer* | 47 |

*Indicates an amount of active stabilizer in the stabilizer package, after subtracting the percent of sugar, which does not have a significant stabilizing effect.

### Example 4

### Evaluation of Various Formulations for Gel Stabilizer Package #1 Series

Additional stabilizer formulations are evaluated to determine the components that contribute to stability and good bead quality, as well as a preferred range for the components in the composition. The various formulations to evaluate are shown in Table 6 below, which shows the weight percent of the ingredients in each of the formulations.

TABLE 6
Gel Stabilizer Package #1 Series Formulations

| | Stabilizer Package Formulation | | | | |
|---|---|---|---|---|---|
| Ingredients Wt % | #1 | #1A | #1B | #1C | #1D |
| Modified Food Starch | 35 | 47.75 | 54 | 43.75 | 45* |
| Guar Gum | 7.5 | 1 | 1 | 9.375 | 7.5 |
| Mono & Diclycerides/ | 20 | 20 | 20 | — | — |
| Polysorbate 80 | | | | | |
| Sodium alginate - | 12.5 | 6.25 | 12.5 | 15.625 | 12.5 |
| gelling type | | | | | |
| Locust bean gum | 12.5 | 12.5 | 6.25 | 15.625 | 12.5 |
| Kappa-type | 12.5 | 12.5 | 6.25 | 15.625 | 12.5 |
| Carrageenan** | | | | | |
| Lecithin | — | — | — | — | 10 |
| Stabilizer*** | 65 | 52.75 | 46 | 56.25 | 75-80 |
| Total | 100 | 100 | 100 | 100 | 100 |

*#1D formulation used two different food starches, one of which was an emulsifying starch.
**Commercial carrageenan including standardizing sugars at levels typically less than 20%.
***Indicates an amount of active stabilizer in the stabilizer package, after subtracting the percent of the modified food starch, which does not have a significant stabilizing effect.

The first formulation, Gel Stabilizer package #1, contains modified food starch, guar gum, a combination of mono- and diglycerides with polysorbate 80, and an equal amount of sodium alginate, locust bean gum, and carrageenan. Using Gel Stabilizer package #1 in frozen pellets made with juice results in good pellet quality and less clumping or fuzing of pellets. However, the composition using Gel Stabilizer package #1 is very thick, which may be a concern from a proccessability standpoint.

The second formulation, Gel Stabilizer package #1A, contains a higher amount of modified food starch, a reduced amount of guar gum and sodium alginate. This formulation produces a lower viscosity composition. Gel Stabilizer package #1B uses an even higher amount of modified food starch, a reduced amount of guar gum, an increased amount of sodium alginate and lower amounts of locust bean gum and carrageenan.

Gel Stabilizer package #1C eliminates the emulsifier, specifically the monoglycerides and diclycerides with polysorbate 80. Instead, Gel Stabilizer package #1C uses a higher amount of guar gum and equal amounts of sodium alginate, locust bean gum and carrageenan. The frozen pellets using formulation #1C are similar to those using formulation #1, but the composition has a more acceptable or preferable viscosity.

Finally, formulation Gel Stabilizer package #1D uses two different types of modified food starch, one of which is an emulsifier. Formulation #1D uses a food starch that may be considered an active ingredient in the stabilizer. In contrast, the modified food starch used in Formulations #1, #1A, #1B and #1C is, for the most part, an inactive ingredient. Formulation #1D also uses lecithin. Formulation #1D results in a composition that is too thick, as compared to the other formulations.

In summary, formulations #1A and #1B did not perform as well in terms of viscosity and pellet quality. However, formulation #1C has similar performance to formulation #1 and eliminates the use of the emulsifiers. It is believed that the equal ratios of carrageenan, locust bean gum and sodium alginate contribute to the stability of the pellets using formulation Gel Stabilizer package #1C. As described above, locust bean gum and kappa-type carrageenan form a gel when combined.

For frozen pellets made with juice and having milk solids, in preferred embodiments, a four part stabilizer is used which includes guar gum, sodium alginate, locust bean gum and carrageenan. Guar gum contributes viscosity; however, its role in stabilizing against pellet fusion is probably less effective than the remaining three components. The emulsifiers in the Gel Stabilizer package #1 Series do not play a role in stability. Emulsifiers may be incorporated in fat containing formulas where they would work to emulsify fat.

### Example 5

### Vanilla-Flavored Frozen Pellets Made with Yogurt

The following procedure was used to form frozen pellets having 94.7 weight percent of milk, 5 weight percent of yogurt, and 0.3 weight percent of vanilla flavoring.

(A) ACTIVE CULTURE CONTAINING YOGURT: 89.29 weight percent milk (3.75 wt % milkfat, 12.6 wt % total solids (T.S.)) is combined with 5 weight percent granulated sugar (sucrose), 4.35 weight percent water, and 0.63 weight percent non-fat dry milk (96 wt % T.S.), and 0.74 wt % Vitex AYD 15 (95 wt % T.S.), a yogurt stabilizer available from Cargill, Incorporated. The ingredients are agitated to foiin a homogeneous mixture. The mixture is pasteurized at 190-195° F. for one minute and homogenized using a first stage at 1500 psi and a second stage at 500 psi. After the mixture has been pasteurized and homogenized, concentrated frozen cultures pellets containing active Lactobacillus acidophilus are inoculated at a rate of 0.01 to 0.02 percent. The mixture containing the culture is allowed to incubate at approximately 105° F. until the pH of the mixture reduces to a pH of 4.5 and yogurt is formed. Thereafter the yogurt is cooled to 45° F. Shear is applied to the yogurt as it is pumped into packaging.

(B) NONFAT MILK MIXTURE: 9.52 weight percent milk (3.75 wt % milkfat, 12.6 wt % total solids (T.S.) is combined with 10.45 weight percent liquid sucrose (aqueous solution, having 67 wt % T.S.), 76.17 weight percent water, 0.52 weight percent non-fat dry milk (96 wt % T.S.), 0.02 weight percent sucralose powder (100 wt % T.S.), 2.38 weight percent 43 DE CS (a corn syrup having 80 wt % T.S.), and 0.95 weight percent of a multicomponent stabilizer package (stabilizer equals 45.5 weight percent), Gel Stabilizer package #2 (see Table 7).

(C) YOGURT CONTAINING MIXTURE: 94.7 weight percent of the milk of mixture (B) is combined with 5 weight percent of the yogurt of (A) and 0.3 weight percent of vanilla flavoring and agitated to form a well mixed blend. The viscosity of the mixture is approximately 80 cP.

(D) FROZEN PELLETS MADE WITH YOGURT: The yogurt containing mixture from (C) is cooled to a temperature of from about 2 to 10° C. and held at that temperature for approximately 0 to 18 hours. The cooled mixture is formed into spherical pellets by passing the mixture through a cryogenic granulator that causes the mixture to form into droplets that are frozen by liquid nitrogen. After forming, the pellets are hardened/tempered by placing them in a freezer having a temperature of from about −10 to −50° C.

Table 7 shows the various components of Gel Stabilizer #2 as used in the nonfat milk mixture of (B) above.

TABLE 7
GEL STABILIZER PACKAGE #2

| Ingredient | % (wt/wt) |
|---|---|
| Citrus Fiber | 6.0% |
| Xanthan Gum | 27.5% |
| Guar Gum | 10.0% |
| Modified Cellulose | 2.0% |
| Salt | 5.0% |
| Modified food starch | 49.5% |
| Total | 100% |
| Stabilizer*** | 45.5% |

***Indicates an amount of active stabilizer in the stabilizer package, after subtracting the percent of inactive ingredients, which do not have a significant stabilizing effect.

The modified food starch in Gel Stabilizer #2 acts mainly as a dispersant and filler in this stabilizer package, and is not believed to significantly contribute to any emulsifying, viscosifying, or hydrocolloid effects at the levels used in the final formulation. Salt is also not considered a stabilizing component within Gel Stabilizer package #2. Therefore, active stabilizer is present in Gel Stabilizer #2 at a level of 45.5 wt % of the entire stabilizer package. Therefore, the nonfat milk mixture of (B) contains 0.43 weight percent active stabilizers (i.e. 45.5*.95).

In a preferred embodiment, the frozen pellets made with yogurt are blended with the frozen pellets made with juice and packaged for shipping and sale. In an alternative embodiment the yogurt containing pellets are packages by themselves, without any additional type of pellet. While the viscosity of the above described pellets made with yogurt is about 80 cP, in a particularly preferred aspect, a sufficient amount of stabilizer is added to the composition used to form the pellets to cause the viscosity of the composition to be from 200 to 600 cP, preferably from 250 to 450 cP, and more preferably from 300 to 350 cP. As discussed earlier, it is believed the higher viscosity improves the mouth feel and creaminess of the pellets and also assists in the effective manufacturing of the pellets. Also, the higher levels of stabilizer will improve the stability of the pellets (reduce the melting rate and/or free flowing nature of the pellets). Too high a level of stabilizer may cause manufacturing difficulties and/or reduce the quality of the pellets.

### Example 6

### Melting Point of Frozen Pellets from Examples 1 and 5

A differential scanning calorimetry (DSC) from TA Instruments is used to determine melting profiles of the frozen pellets from Examples 1 and 5. Samples are kept and prepared in a Styrofoam™ box with dry ice to prevent melting of the samples before loading the DSC. DSC sample panes are also kept in dry ice. For each of Example 1 and 5, samples of 10-15 mg are placed into a sample holder. DSC sample loading temperatures are adjusted to −15° C. to prevent melting during loading and at the beginning of a heating scan. The temperature profile is a hold at −15° C. for a minute, then further cooling to −30° C. at a rate of 5° C./min and heating from −30° C. to 40° C. at a rate of 5° C./min. The start of melting temperature is determined as a temperature where melting of pellets start. In addition, the onset temperature of the melting peak is chosen as a melting point temperature.

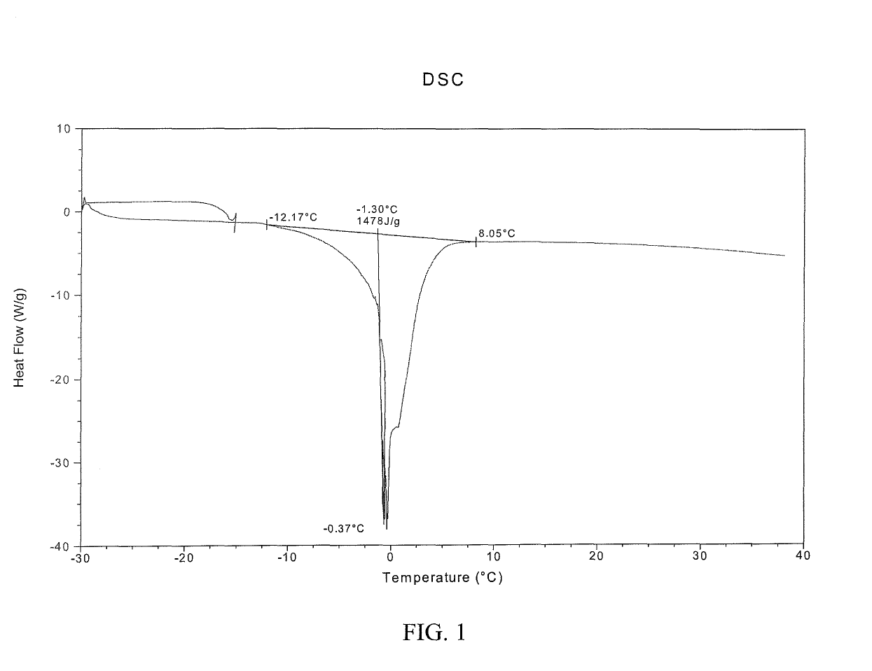

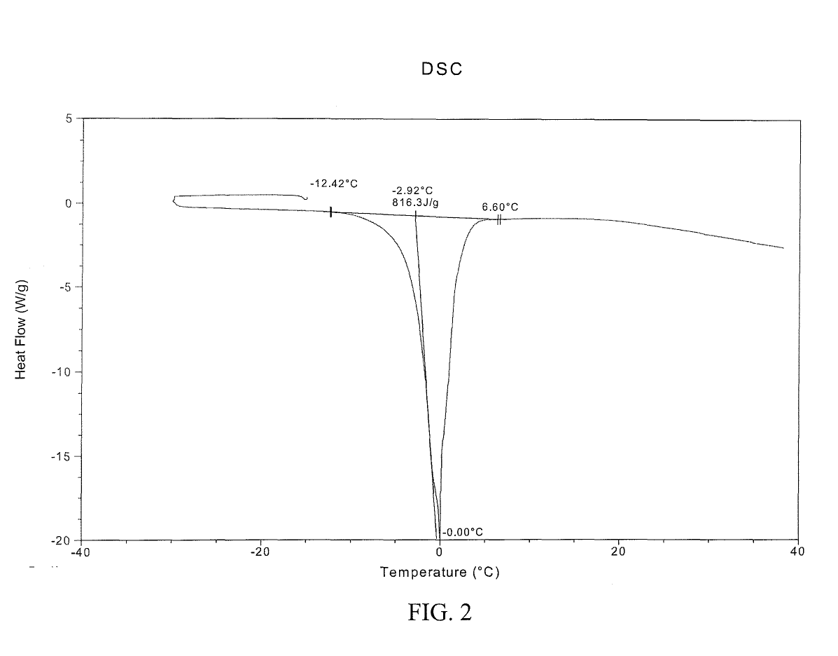

FIG. 1 is a graph of the melting profile of the strawberry pellets from Example 1. FIG. 2 is a graph of the melting profile of the vanilla flavored pellets made with yogurt from Example 5. The results from FIGS. 1 and 2 are shown in Table 8 below.

TABLE 8
DSC Results for Examples 1 and 5

| | Strawberry Pellets | Pellets made with Yogurt |
|---|---|---|
| | (Ex 1) | (Ex 5) |
| Melting Start | −12.6° C. | −13.3° C. |
| Temperature | (9.3° F.) | (8.1° F.) |
| Melting Onset | −1.3° C. | −2.9° C. |
| Temperature | (30° F.) | (26.8° F.) |

As shown in Table 8, the melting start temperature of both the strawberry pellets and the pellets made with yogurt is higher than a normal freezer temperature (i.e. about 0° F. to −4° F., about −17.8° C. to −20° C.). Moreover, the melting start temperature is higher than an expected temperature of the freezer during normal freeze/thaw or defrost cycles. The melting onset temperature represents the temperature at which the majority of the material melts during the test. Both the strawberry pellets and the pellets made with yogurt have a melting onset temperature that is much higher than any temperature expected in a properly operating freezer. The results of FIGS. 1 and 2 and Table 8 indicate that the frozen pellets of Examples 1 and 2 are able to remain stable during storage in the freezer and have excellent flowability under typical freezer conditions. Moreover, the pellets will be more resistant to melting for some period of time after removal from the freezer.

The results of FIGS. 1 and 2 and Table 8 indicate that the formulations from Examples 1 and 5 result in pellets have excellent melting behavior, exhibiting melting points greater than −4° C. Preferably the frozen pellets of the invention have a melting point greater than −3° C., and more preferably greater than −2° C., as exhibited by the results of the strawberry pellets (example 1) shown in Table 8. This results in pellets that melt slowly when removed from the freezer.

### Example 7

### Melting Rate of Frozen Pellets from Examples 1 and 5

Melting rate of the frozen pellets is measured for Examples 1 and 5. First, 50 g of the sample is placed on a No. 6 mesh sieve in an environment controlled at 21° C. (about room temperature). The sample drips into a collection port that is on top of a scale. An amount of material dropped onto the top of the scale is measured every two minutes. This melting rate test is a commonly used test for ice cream products. The test is particularly useful for comparing the melting resistance of more than one formulation.

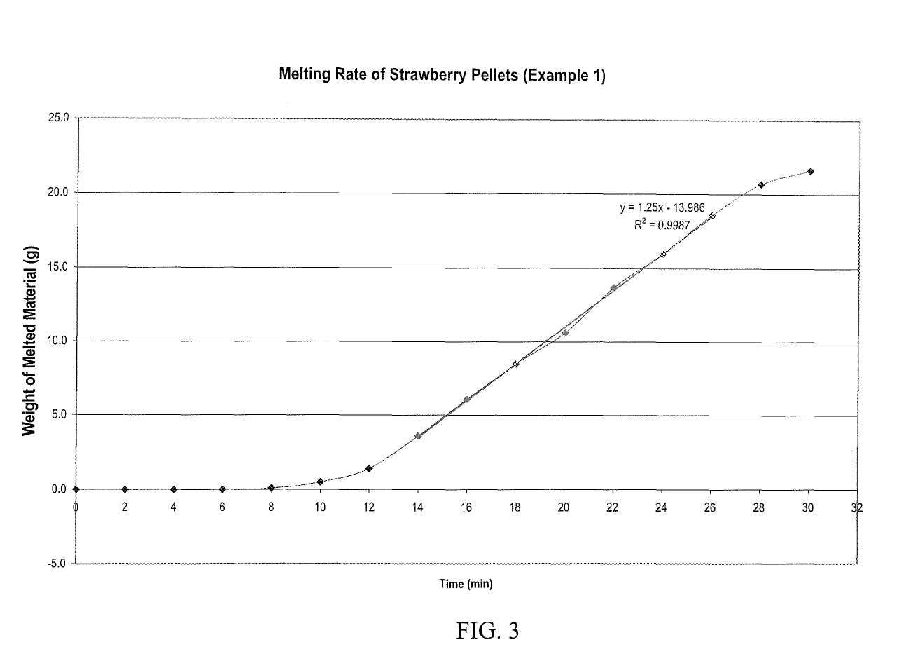

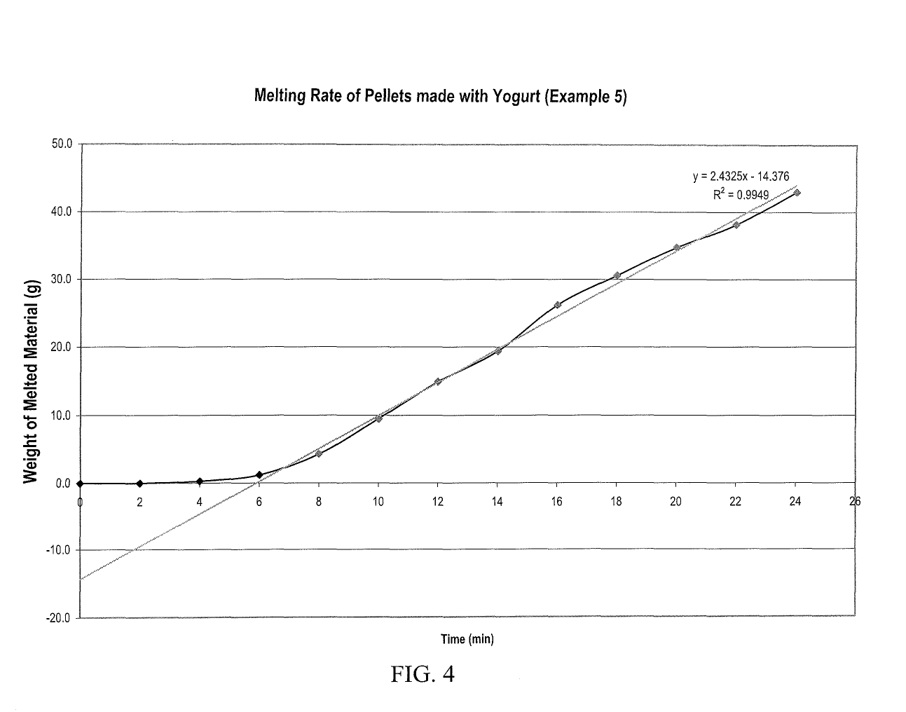

The melting rate for the strawberry pellets from Example 1 is shown in FIG. 3 and Table 9 below. The melting rate for the pellets made with yogurt from Example 5 is shown in FIG. 4 and Table 10 below. As shown in Table 9, Wt is the weight of the composition which melts and collects in the collection port over time (including any material that was present in the port at the start of the test (Wt₀)). The value Wt₀ is the weight of the composition in the port at the start of the test. Thus the values shown in Tables 9 and 10, and plotted in FIGS. 3 and 4, represent the difference between the weight of the composition in the port, as measured every two minutes, and the weight of the composition in the port at the start of the test.

TABLE 9
Melting Rate of Strawberry Pellets from Example 1

| Time | Wt- |
|---|---|
| (min) | Wt₀ |
| 0 | 0.0 |
| 2 | 0.0 |
| 4 | 0.0 |
| 6 | 0.0 |
| 8 | 0.1 |
| 10 | 0.5 |
| 12 | 1.4 |
| 14 | 3.6 |
| 16 | 6.1 |
| 18 | 8.5 |
| 20 | 10.6 |
| 22 | 13.7 |
| 24 | 16.0 |
| 26 | 18.6 |
| 28 | 20.7 |
| 30 | 21.6 |

TABLE 10
Melting Rate of Pellets made with Yogurt from Example 5

| Time | Wt- |
|---|---|
| (min) | Wt₀ |
| 0 | 0.0 |
| 2 | 0.0 |
| 4 | 0.3 |
| 6 | 1.2 |
| 8 | 4.3 |
| 10 | 9.5 |
| 12 | 14.9 |
| 14 | 19.4 |
| 16 | 26.2 |
| 18 | 30.6 |
| 20 | 34.8 |
| 22 | 38.2 |
| 24 | 43.0 |

### Example 8

### Frozen Food Product having Blend of Frozen Pellets from Examples 1 and 5

Frozen pellets made with juice from Example 1 above are blended with frozen pellets made with yogurt from Example 5 above to make a frozen food product. The pellets in Example 1 are strawberry flavored and the pellets made with yogurt in Example 5 are vanilla flavored, resulting in a frozen food product having a strawberry vanilla flavoring and taste similar to a smoothie. The blend of strawberry flavored pellets to vanilla flavored pellets is approximately 1 to 1. It is recognized that any type of blend may be used (2:1; 3:1; 1:2, 1:3 etc.).

### Example 9

### Evaluation of Various Stabilizer Formulations in Strawberry Pellets

As described above under Example 4, Gel Stabilizer package #1C exhibits similar performance to Gel Stabilizer package #1 in terms of pellet quality and clumping. A benefit of stabilizer package #1C is that it does not include monoglycerides and diglycerides. Additional stabilizer formulations are evaluated in this example and compared to Gel Stabilizer package #1C. The various stabilizer formulations are shown in Table 11 below and are incorporated into the frozen pellets formulation.

TABLE 11
Stabilizer Formulations in Strawberry Pellets

| | Formulation | | | | | | | |
|---|---|---|---|---|---|---|---|---|
| | 9A | | 9B | | 9C | | 9D | |
| | % | | % | | % | | % | |
| Ingredients | (wt/wt) | wt (g) | (wt/wt) | wt (g) | (wt/wt) | wt (g) | (wt/wt) | wt (g) |
| Water | 75.990 | 6,079.20 | 76.574 | 6,125.92 | 76.746 | 6,139.68 | 76.918 | 6,153.44 |
| Strawberry Juice | 6.154 | 492.32 | 6.154 | 492.32 | 6.154 | 492.32 | 6.154 | 492.32 |
| Concentrate, 65 Brix | | | | | | | | |
| Pear Juice | 4.286 | 342.88 | 4.286 | 342.88 | 4.286 | 342.88 | 4.286 | 342.88 |
| Concentrate, 70 Brix | | | | | | | | |
| Apple Juice | 4.109 | 328.72 | 4.109 | 328.72 | 4.109 | 328.72 | 4.109 | 328.72 |
| Concentrate, 70 Brix | | | | | | | | |
| Nonfat Dry Milk | 4.000 | 320.00 | 4.000 | 320.00 | 4.000 | 320.00 | 4.000 | 320.00 |
| Inulin, Oliggo-Fiber | 2.000 | 160.00 | 2.000 | 160.00 | 2.000 | 160.00 | 2.000 | 160.00 |
| LCHT, Cargill | | | | | | | | |
| Heavy Whipping | 1.950 | 156.00 | 1.950 | 156.00 | 1.950 | 156.00 | 1.950 | 156.00 |
| Cream | | | | | | | | |
| Guar Gum | 0.103 | 8.25 | 0.000 | 0.00 | 0.000 | 0.00 | 0.000 | 0.00 |
| Carrageenan | 0.172 | 13.75 | 0.172 | 13.76 | 0.172 | 13.76 | 0.000 | 0.00 |
| Locust bean gum | 0.172 | 13.75 | 0.172 | 13.76 | 0.172 | 13.76 | 0.000 | 0.00 |
| Alginate | 0.172 | 13.75 | 0.172 | 13.76 | 0.000 | 0.00 | 0.172 | 13.76 |
| Modified Food | 0.481 | 38.50 | 0.000 | 0.00 | 0.000 | 0.00 | 0.000 | 0.00 |
| Starch | | | | | | | | |
| Natural Flavor, | 0.390 | 31.20 | 0.390 | 31.20 | 0.390 | 31.20 | 0.390 | 31.20 |
| Strawberry | | | | | | | | |
| Sucralose | 0.019 | 1.52 | 0.019 | 1.52 | 0.019 | 1.52 | 0.019 | 1.52 |
| FD&C Red 40 | 0.002 | 0.16 | 0.002 | 0.16 | 0.002 | 0.16 | 0.002 | 0.16 |
| | 100.0 | 8,000.0 | 100.0 | 8,000.0 | 100.0 | 8,000.0 | 100.0 | 8,000.0 |

Table 12 shows the viscosities of each of the formulations as measured at 50 rpm and 100 rpm using a Brookfield rotational viscometer fitted with a LV3 spindle.

TABLE 12
Viscosity of Formulations from Table 11

| | 9A | 9B | 9C | 9D |
|---|---|---|---|---|
| 50 rpm | 139.2 | 124.8 | 9.6 | * |
| 100 rpm | 129.6 | 85.2 | 14.4 | 1.2 |

* Composition was too thin to get a viscosity reading.

The strawberry pellets of Formulation 9A are essentially the same as the strawberry pellets in Example 1. Formulations 9B, 9C and 9D have the same ingredients as Formulation 9A, with the exception of varying stabilizer components. Similar to the strawberry pellets of Example 1, each of the formulations for the strawberry pellets in Table 11 contain soluble juice solids equivalent to 100% juice (i.e. 100 weight equivalents of juice).

The stabilizer composition of Formulation 9A is the same as Gel Stabilizer package #1C of Example 4 and includes guar gum, carrageenan, locust bean gum, and alginate. The strawberry pellets made using Formulation 9A exhibit good pellet quality; however, some clumping is observed when the frozen pellets are checked on approximately 40 days after forming the frozen pellets. A viscosity of the melted pellets of Formulation 9A is approximately 139 cP at 50 rpm and approximately 130 cP at 100 rpm.

The stabilizer composition of Formulation 9B includes carrageenan, locust bean gum and alginate. The weight percent of each component of the stabilizer in Formulation 9B is the same as that component in Formulation 9A. A viscosity of the melted pellets of Formulation 9B is approximately 125 cp at 50 rpm and approximately 85 cP at 100 rpm. The stabilizer composition of Formulation 9C includes carrageenan and locust bean gum. A viscosity of the melted pellets of Formulation 9C is approximately 10 cP at 50 rpm and approximately 14 cP at 100 rpm. The stabilizer composition of Formulation 9D includes only alginate. A viscosity of the melted pellets of Formulation 9D is too thin to be measurable at 50 rpm and approximately 1.2 cP at 100 rpm. The viscosity results show that, as stabilizer components are removed from the juice pellets formulations, the viscosity of the melted pellets decreases.

As described above under Example 1, the procedure for making the pellets includes filling the mixture into two liter containers and then storing the mixture in a refrigerator. For Formulations 9C and 9D, when the mixture is removed from the refrigerator the day after forming the mixture, the composition separates into two phases—he top phase is a red, translucent layer; the bottom phase is a sediment layer. However, after agitating the container containing the mixture, the distinct phases go away and the composition looks relatively homogeneous. This phase separation does not appear to impact the pellet quality.

Of the formulations shown in Table 11, Formulation 9A appears to have the best pellet quality. Formulation 9D exhibits the least amount of clumping of pellets after approximately 40 days.

In this example, as well as Example 10 below, the viscosity of Formulations 9A, 9B, 9C, and 9D is conducted by applying heat to the already formed frozen pellets to melt the pellets, and then measuring viscosity using a Brookfield rotational viscometer fitted with a LV3 spindle and measured at 50 rpm and 100 rpm. Alternatively, the frozen pellets may be left at ambient conditions for a sufficient period of time such that the pellets are essentially melted before viscosity is measured. The viscosity measurements disclosed elsewhere in the application were conducted on the composition used to form the juice pellets before the composition was processed through the cryogran that forms the frozen pellets. As stated above, the viscosity of Formulation 9A is approximately 139 cP at 50 rpm. The composition used to form the frozen juice pellets from Example 1, having essentially the same formulation, has a measured viscosity of approximately 310 cP at 50 rpm. It is expected that the difference in viscosity between Example 1 and Formulation 9A may be due, in part, to measuring the viscosity at different points in the process of forming the frozen pellets.

As exhibited by Table 12, the viscosity depends in part on the rpm setting of the viscometer. Moreover, in this example and Example 10 below, the temperatures of the compositions at the time the viscosity measurement is performed vary between approximately 66 degrees Fahrenheit (18.9 degrees Celsius) and 75 degrees Fahrenheit (23.9 degrees Celsius), which may be considered within a normal room temperature range. As is well-known, the temperature of the composition does impacts the viscosity. For purposes of this example and Example 10 below, the viscosity measurements of Formulations 9A-9D and 10A-10D may still be used to effectively compare the different stabilizer formulations.

### Example 10

### Evaluation of Additional Stabilizer Formulations in Strawberry Pellets

In this example, four additional stabilizer compositions were used to make four formulations of strawberry pellets having the compositions shown below in Table 13. Each of Formulations 10A, 10B, 10C and 10D contain soluble juice solids equivalent to 100% juice.

TABLE 13
Additional Stabilizer Formulations in Strawberry Pellets

| | Formulation | | | | | | | |
|---|---|---|---|---|---|---|---|---|
| | 10A | | 10B | | 10C | | 10D | |
| | % | | % | | % | | % | |
| Ingredients | (wt/wt) | wt (g) | (wt/wt) | wt (g) | (wt/wt) | wt (g) | (wt/wt) | wt (g) |
| Water | 76.140 | 6,091.20 | 76.829 | 6,146.32 | 76.734 | 6,138.72 | 76.772 | 6,141.76 |
| Strawberry Juice | 6.154 | 492.32 | 6.154 | 492.32 | 6.154 | 492.32 | 6.154 | 492.32 |
| Concentrate, 65 Brix | | | | | | | | |
| Pear Juice | 4.286 | 342.88 | 4.286 | 342.88 | 4.286 | 342.88 | 4.286 | 342.88 |
| Concentrate, 70 Brix | | | | | | | | |
| Apple Juice | 4.109 | 328.72 | 4.109 | 328.72 | 4.109 | 328.72 | 4.109 | 328.72 |
| Concentrate, 70 Brix | | | | | | | | |
| Nonfat Dry Milk | 4.000 | 320.00 | 4.000 | 320.00 | 4.000 | 320.00 | 4.000 | 320.00 |
| Inulin, Oliggo-Fiber | 2.000 | 160.00 | 2.000 | 160.00 | 2.000 | 160.00 | 2.000 | 160.00 |
| LCHT, Cargill | | | | | | | | |
| Heavy Whipping | 1.950 | 156.00 | 1.950 | 156.00 | 1.950 | 156.00 | 1.950 | 156.00 |
| Cream | | | | | | | | |
| Xanthan Gum | 0.261 | 20.88 | 0.261 | 20.88 | 0.261 | 20.88 | 0.261 | 20.88 |
| Guar Gum | 0.095 | 7.60 | 0.000 | 0.00 | 0.095 | 7.60 | 0.000 | 0.00 |
| Citrus Fiber | 0.057 | 4.56 | 0.000 | 0.00 | 0.000 | 0.00 | 0.057 | 4.56 |
| Modified cellulose | 0.019 | 1.52 | 0.000 | 0.00 | 0.000 | 0.00 | 0.000 | 0.00 |
| Salt | 0.048 | 3.84 | 0.000 | 0.00 | 0.000 | 0.00 | 0.000 | 0.00 |
| Modified food | 0.470 | 37.60 | 0.000 | 0.00 | 0.000 | 0.00 | 0.000 | 0.00 |
| starch | | | | | | | | |
| Natural Flavor, | 0.390 | 31.20 | 0.390 | 31.20 | 0.390 | 31.20 | 0.390 | 31.20 |
| Strawberry | | | | | | | | |
| Sucralose | 0.019 | 1.52 | 0.019 | 1.52 | 0.019 | 1.52 | 0.019 | 1.52 |
| FD&C Red 40 | 0.002 | 0.16 | 0.002 | 0.16 | 0.002 | 0.16 | 0.002 | 0.16 |
| | 100.000 | 8,000.00 | 100.000 | 8,000.00 | 100.000 | 8,000.00 | 100.000 | 8,000.00 |

Table 14 shows the viscosities of each of the formulations as measured at 50 rpm and 100 rpm using a Brookfield rotational viscometer fitted with a LV3 spindle.

TABLE 14
Viscosity of Formulations from Table 12

| | 10A | 10B | 10C | 10D |
|---|---|---|---|---|
| 50 rpm | 168 | * | 21.6 | 7.2 |
| 100 rpm | 82.8 | 3.6 | 20.4 | 9.6 |

* Composition was too thin to get a viscosity reading.

The stabilizer composition of Formulation 10A is the same as Gel Stabilizer Package #2 of Example 5. The active stabilizer components of Formulation 10A include xanthan gum, guar gum, citrus fiber, and modified cellulose. A viscosity of the melted pellets of Formulation 10A is approximately 168 cP at 50 rpm and approximately 83 cP at 100 rpm.

The stabilizer composition of Formulation 10B includes only xanthan gum and thus the melted pellets of Formulation 10B have a significantly lower viscosity (not measurable at 50 rpm and approximately 3.6 cP at 100 rpm) compared to Formulation 10A. Formulation 10C includes xanthan gum and guar gum, and the melted pellets have a viscosity of approximately 22 cP at 50 rpm and approximately 20 cP at 100 rpm. Formulation 10D includes xanthan gum and citrus fiber, and the melted pellets a viscosity of approximately 7 cP at 50 rpm and approximately 10 cP at 100 rpm.

Among Formulations 10A, 10B, 10C and 10D, Formulation 10A exhibits the best pellet quality, resulting in homogeneous pellets. The pellets of Formulations 10B and 10C are non-uniform and include air pockets. However, the pellets of Formulation 10B are better than Formulation 10C in teens of overall pellet quality.

After removing the mixtures from the refrigerator a day after forming the mixtures, Formulation 10B separates into a cloudy layer and a sediment layer. Similar to Formulations 9C and 9D, Formulations 10C and 10D separate into a sediment layer on top and a translucent red layer on bottom. After agitating the containers containing the mixtures, the separation no longer exists and is not believed to impact the pellet quality. Approximately 35 days after the pellets are formed, the pellets of Formulations 10A, 10B, 10C and 10D are observed for clumping. Formulation 10B exhibits the least amount of clumping.

### Example 11

### Melting Rates of Frozen Juice Pellets from Example 9

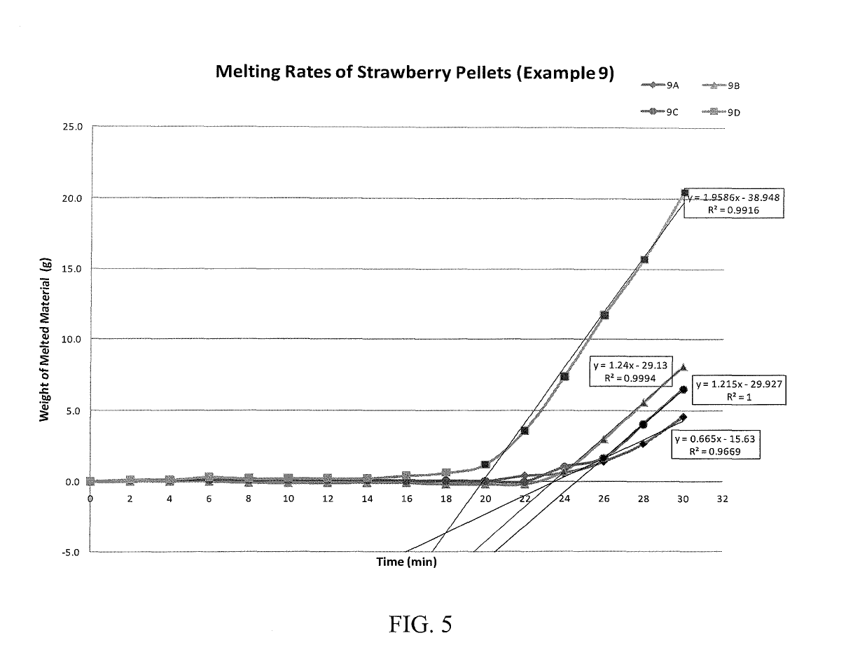

The melting rates of the frozen pellets from Example 9 (Formulations 9A-9D) are measured using the method described above in Example 7. The results are shown in Table 15 below and FIG. 5. As described above under Example 7, the values in Table 15 represent the difference between the weight of the composition in the collection port at a particular time and the weight of the composition in the port at the start of the test.

TABLE 15
Melting Rates of Strawberry Pellets from Example 9

| Time | 9A | 9B | 9C | 9D |
|---|---|---|---|---|
| (min) | Wt-Wt₀ | Wt-Wt₀ | Wt-Wt₀ | Wt-Wt₀ |
| 0 | 0.0 | 0.0 | 0.0 | 0.0 |
| 2 | 0.0 | 0.0 | 0.0 | 0.0 |
| 4 | 0.0 | 0.0 | 0.0 | 0.0 |
| 6 | 0.0 | 0.0 | 0.0 | 0.0 |
| 8 | 0.0 | 0.0 | 0.0 | 0.0 |
| 10 | 0.0 | 0.0 | 0.0 | 0.0 |
| 12 | 0.0 | 0.0 | 0.0 | 0.0 |
| 14 | 0.0 | 0.0 | 0.0 | 0.0 |
| 16 | 0.0 | 0.0 | 0.0 | 0.4 |
| 18 | 0.0 | 0.0 | 0.0 | 0.6 |
| 20 | 0.0 | 0.0 | 0.0 | 1.2 |
| 22 | 0.4 | 0.0 | 0.0 | 3.6 |
| 24 | 0.6 | 0.7 | 1.0 | 7.4 |
| 26 | 1.4 | 3.0 | 1.7 | 11.7 |
| 28 | 2.7 | 5.6 | 4.1 | 15.7 |
| 30 | 4.6 | 8.1 | 6.5 | 20.5 |

It is observed across Formulations 9A-9D that a lot of the melted composition does not drip through the sieve, but rather sits on top of the sieve. Moreover, it is observed, particularly for Formulations 9A, 9B and 9C, that water leaks out of the pellets remaining on top of the sieve, and the water falls through the sieve.

### Example 12

### Melting Rates of Frozen Juice Pellets from Example 10

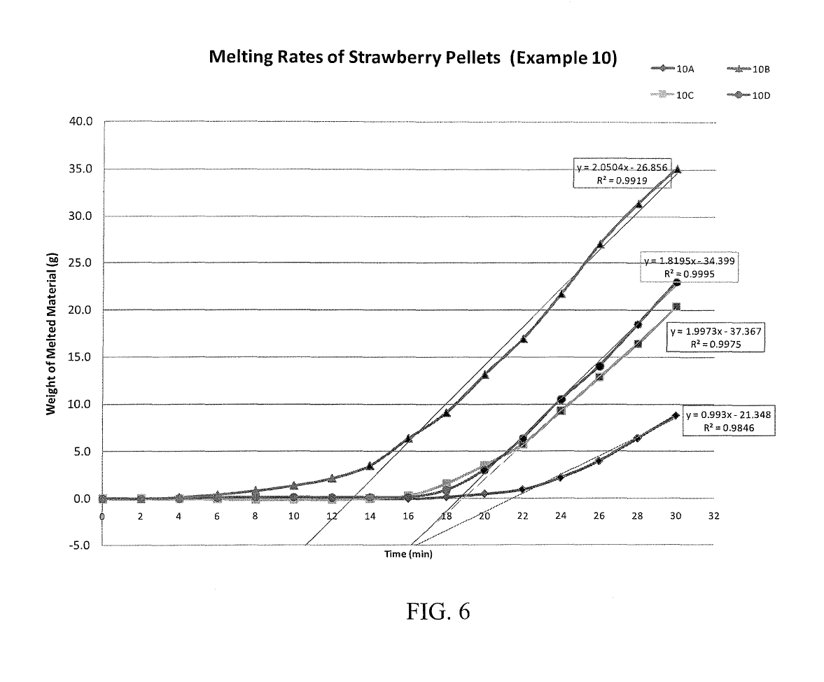

Similar to Example 11, the melting rates of the frozen pellets from Example 10 (Formulations 10A-10D) are also measured using the method described above in Example 7. The results are shown in Table 16 below and FIG. 6.

TABLE 16
Melting Rates of Strawberry Pellets from Example 10

| Time | 10A | 10B | 10C | 10D |
|---|---|---|---|---|
| (min) | Wt-Wt₀ | Wt-Wt₀ | Wt-Wt₀ | Wt-Wt₀ |
| 0 | 0.0 | 0.0 | 0.0 | 0.0 |
| 2 | 0.0 | 0.0 | 0.0 | 0.0 |
| 4 | 0.0 | 0.2 | 0.0 | 0.0 |
| 6 | 0.0 | 0.4 | 0.0 | 0.1 |
| 8 | 0.0 | 0.9 | 0.0 | 0.1 |
| 10 | 0.0 | 1.4 | 0.0 | 0.1 |
| 12 | 0.0 | 2.2 | 0.0 | 0.1 |
| 14 | 0.0 | 3.5 | 0.0 | 0.1 |
| 16 | 0.0 | 6.4 | 0.3 | 0.1 |
| 18 | 0.2 | 9.1 | 1.6 | 0.9 |
| 20 | 0.5 | 13.1 | 3.5 | 3.0 |
| 22 | 1.0 | 17.0 | 5.7 | 6.4 |
| 24 | 2.2 | 21.7 | 9.2 | 10.5 |
| 26 | 4.0 | 27.0 | 12.8 | 14.0 |
| 28 | 6.4 | 31.4 | 16.4 | 18.5 |
| 30 | 8.8 | 35.1 | 20.4 | 23.0 |

As similarly observed under Example 11, observations for Formulations 10A-10D include melted material sitting on the top of the sieve and not dripping through, as well as water leaking out of the pellets and dripping through the sieve.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A frozen food product in pellet form, wherein the food product is formed from a composition comprising:
at least about 50 weight equivalents of juice;
a multipart stabilizer that acts as a gelling agent and a viscosifying agent, wherein a viscosity of the composition is at least 250 centipoise.

2. The food product of claim 1 wherein the juice comprises:
a first juice that provides flavor to the composition; and
a second juice that provides sweetness and flavor to the composition, wherein the flavor provided by the second juice is lower than the flavor provided by the first juice.

3. The food product of claim 2 wherein the second juice has a single strength Brix value less than 13.

4. (canceled)

5. The food product of claim 2 wherein the second juice includes at least one of apple juice and pear juice.

6. The food product of claim 1 wherein the multipart stabilizer includes at least two components.

7-8. (canceled)

9. The food product of claim 1 wherein the multipart stabilizer includes at least one of carrageenan, locust bean gum, xanthan gum, guar gum, and sodium alginate.

10. The food product of claim 1 further comprising at least about two weight percent of milk solids.

11. The food product of claim 1 wherein the composition has a melting point greater than about −4 degrees Celsius.

12. A frozen food product comprising:
a plurality of substantially, free flowing pellets formed from a composition comprising:
at least about 50 weight equivalents of juice;
milk solids comprising at least about 2.0 weight percent of the composition; and
a multipart stabilizer that acts as a gelling agent and a viscosifying agent to increase a thickness of the composition used to form the pellets as compared with a comparable composition not containing the multipart stabilizer.

13-15. (canceled)

16. The frozen food product of claim 12 wherein the juice in the composition comprises:
a first juice that provides flavor to the composition; and
a second juice that provides sweetness and flavor to the composition, wherein the flavor of the second juice is lower than the flavor of the first juice.

17. The food product of claim 16 wherein the second juice has a single strength Brix value less than 13.

18. The food product of claim 16 wherein the second juice is selected from the group consisting of apple juice, pear juice and mixtures thereof.

19. The frozen food product of claim 12 wherein the substantially free flowing pellets do not exhibit any appreciable clumping at a temperature less than about −20 degrees Celsius.

20. The frozen food product of claim 12 wherein the multipart stabilizer comprises sodium alginate.

21. The frozen food product of claim 12 wherein the multipart stabilizer is selected from the group consisting of carageenan, locust bean gum, guar gum, and xanthan gum.

22. The frozen food product of claim 12 wherein the substantially free flowing pellets have an average diameter from about 1 to about 20 millimeters.

23-34. (canceled)

35. A method for making a frozen food product, the method comprising:
a) obtaining a composition comprising:
about 50 to about 100 weight equivalents of juice;
about 2 to about 5 weight percent of milk solids; and
a multipart stabilizer comprising a viscosifying agent and a gelling agent;
b) pasteurizing the composition; and
c) cryogenically freezing the composition to form a plurality of free flowing pellets.

36-37. (canceled)

38. The method of claim 35 wherein the composition has a viscosity, prior to cryogenically freezing in step c), from about 250 to about 450 centipoise.

39. (canceled)

40. The method of claim 35 wherein the juice includes at least one juice concentrate selected from a group consisting of apple juice concentrate, pear juice concentrate, strawberry juice concentrate, white grape juice concentrate, orange juice concentrate, raspberry juice concentrate, lemon juice concentrate, lime juice concentrate and combinations thereof.

41. The method of claim 35 wherein the multipart stabilizer includes at least two components.

42. (canceled)

43. The method of claim 35 wherein the multipart stabilizer includes at least one of sodium alginate, carrageenan, locust bean gum, xanthan gum and guar gum.

44. The method of claim 35 further comprising:
making a second set of free flowing pellets from a second composition comprising:
nonfat milk;
at least three weight percent yogurt; and
a stabilizer comprising at least one of citrus fiber, xanthan gum and guar gum.

45. The method of claim 44 wherein the nonfat milk and the stabilizer are premixed before being combined with the yogurt, and the nonfat milk and stabilizer mixture is pasteurized prior to being combined with the yogurt.

46-50. (canceled)
